(19) United States
(12) Patent Application Publication
(10) Pub. No.: US 2007/0094274 A1
(43) Pub. Date: Apr. 26, 2007

(54) Content transfer apparatus, content transfer method and content transfer program

(75) Inventor: Yongjin Jung, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/544,985

(22) Filed: Oct. 6, 2006

(30) Foreign Application Priority Data
Oct. 7, 2005 (JP) P2005-295206

(51) Int. Cl. G06F 17/30

(52) U.S. Cl. 707/10

(57) ABSTRACT

A content transfer apparatus, method and program permit an amount of content data as great as possible to be provided to a user in accordance with the use time set by the user. The content transfer apparatus includes a communication section configured to communicate with an external apparatus, a storage section configured to store a plurality of content data, a designation section configured to designate at least part of the content data as transfer content data to be transferred to the external apparatus from the storage section based on a preset time set in advance, and a control section configured to control the communication section to transfer the transfer content data to the external apparatus.

### CROSS-REFERENCE TO RELATED APPLICATIONS

The present application claims priority from Japanese Patent Application No. JP 2005-295206 filed on Oct. 7, 2005, the disclosure of which is hereby incorporated by reference herein.

### BACKGROUND OF THE INVENTION

1. Field of the Invention

This invention relates to a content transfer apparatus, a content transfer method and a content transfer program, and more particularly to a content transfer apparatus, a content transfer method and a content transfer program which are suitably applied to a content transfer system wherein content data are transferred to a content reproduction apparatus typically from a content storage apparatus which stores and retains content data.

2. Description of Related Art

Typically, a music transfer system wherein music data are transferred is conventionally available as a content transfer system of the type described. Actually, in the music transfer system, if music data to be transferred from a music server as a content server to a portable audio player as a content reproduction apparatus are selected by a user, then a transfer list which represents music data identification information for the identification of the selected music data is produced. Then, in the music transfer system, when the music server and the portable audio player are connected to each other, the music data identified with the music data identification information in the produced transfer list are transferred from the music server to the portable audio player so that the portable audio player acquires the music data. A music transfer system of the type just described is disclosed in Japanese Patent Laid-open No. 2001-93226.

Also another content transfer system is known which not only allows a user itself to select music data to be transferred to a portable audio player but also selects music data to be transferred automatically, for example, based on user preference information of the user so that music data can be transferred more readily.

Incidentally, the period of time within which a content reproduction apparatus such as a portable audio player is used continuously by a user (such a period of time is hereinafter referred to also as use time) is actually restricted frequently, for example, to commuter time. In other words, it can be considered that this time is a continuously reproducible time period on a content reproduction apparatus.

Where the use time is restricted in this manner, even if content data having reproduction time which is longer than the use time are stored in the content reproduction apparatus, the user cannot enjoy all of contents based on the content data at a time. As a result, even if content data having reproduction time longer than the use time are transferred from a content server to the content reproduction apparatus, a portion of the content data received by the content reproduction apparatus which protrudes from the use time comes to naught.

Further, the storage capacity of the content reproduction apparatus is wasted by a wasteful portion of content data which protrudes from the use time, and the capacity which can be used for storage of other content data decreases as much. As a result, there is a problem that the number of content data which can be transferred from the content server to the content reproduction apparatus decreases and, as a result, the number of contents which can be provided to the user decreases.

Therefore, it is demanded to provide a content transfer apparatus, a content transfer method and a content transfer program by which an amount of content data as great as possible can be provided to a user in accordance with the use time set by the user.

### SUMMARY OF THE INVENTION

According to the present invention, there is provided a content transfer apparatus including a communication section configured to communicate with an external apparatus, a storage section configured to store a plurality of content data, a designation section configured to designate at least part of the content data as transfer content data to be transferred to the external apparatus from the storage section based on a preset time set in advance, and a control section configured to control the communication section to transfer the transfer content data to the external apparatus.

In the content transfer apparatus, if a use time of the external apparatus is set in advance by the user, then content data each of which has a data amount corresponding to the use time can be transferred to the external apparatus. Consequently, an amount of content data as great as possible can be transferred to the external apparatus without transferring a useless portion of content data which extends beyond the use time. Consequently, with the content transfer apparatus, content transfer method and content transfer program according to the present invention, an amount of content data as great as possible can be provided to the user in accordance with the use time set by the user.

The above and other objects, features and advantages of the present invention will become apparent from the following description and the appended claims, taken in conjunction with the accompanying drawings in which like parts or elements are denoted by like reference symbols.

### BRIEF DESCRIPTION OF THE DRAWINGS

FIG. 1 is a block diagram showing an outline of a content transfer apparatus to which the present invention is applied;

FIG. 2 is a schematic view showing a general configuration of a content transfer system in which the content transfer apparatus is used;

FIG. 3 is a block diagram showing a configuration of a content providing server shown in FIG. 2;

FIG. 4 is a block diagram showing a configuration of a content reproduction terminal shown in FIG. 2;

FIG. 5 is a block diagram showing a configuration of a portable content reproduction apparatus shown in FIG. 2;

FIG. 6 is a view illustrating the substance of attribute information to be added to content data used in the content transfer system;

FIG. 7 is a schematic view illustrating content data stored and retained in the content reproduction terminal;

FIG. 8 is a diagrammatic view illustrating production of a transfer list by the content transfer apparatus;

FIG. 9 is a diagrammatic view illustrating transfer of contents in the content transfer system;

FIG. 10 is a view illustrating the substance of management information immediately after transferred;

FIG. 11 is a view illustrating the substance of the management information after reproduction;

FIG. 12 is a diagrammatic view illustrating index information;

FIG. 13 is a schematic view showing a table display screen of contents;

FIG. 14 is a schematic view showing a content being reproduced which is displayed on a display section;

FIG. 15 is a schematic view showing the content upon stopping which is displayed on the display screen;

FIG. 16 is a flow chart illustrating a procedure of a content reproduction process according to a first embodiment of the present invention;

FIG. 17 is a flow chart illustrating a procedure of a content transfer process according to the first embodiment;

FIG. 18 is a flow chart illustrating a procedure of a storable time detection process according to the first embodiment;

FIG. 19 is a flow chart illustrating a procedure of a transfer list production process according to the first embodiment;

FIG. 20 is a flow chart illustrating a procedure of a data transfer process according to a first embodiment of the present invention;

FIG. 21 is a flow chart illustrating a procedure of a storable time detection process according to a second embodiment of the present invention;

FIG. 22 is a flow chart illustrating a procedure of a storable time detection process according to a third embodiment of the present invention;

FIG. 23 is a flow chart illustrating a procedure of a content reproduction process according to a fourth embodiment of the present invention;

FIG. 24 is a flow chart illustrating a procedure of a transfer list production process according to a fifth embodiment of the present invention;

FIGS. 25A and 25B are diagrammatic views illustrating partial addition to a content being reproduced; and

FIG. 26 is a flow chart illustrating a procedure of a transfer list production process according to a sixth embodiment of the present invention.

### DETAILED DESCRIPTION

1. First Embodiment

1-1. Outline

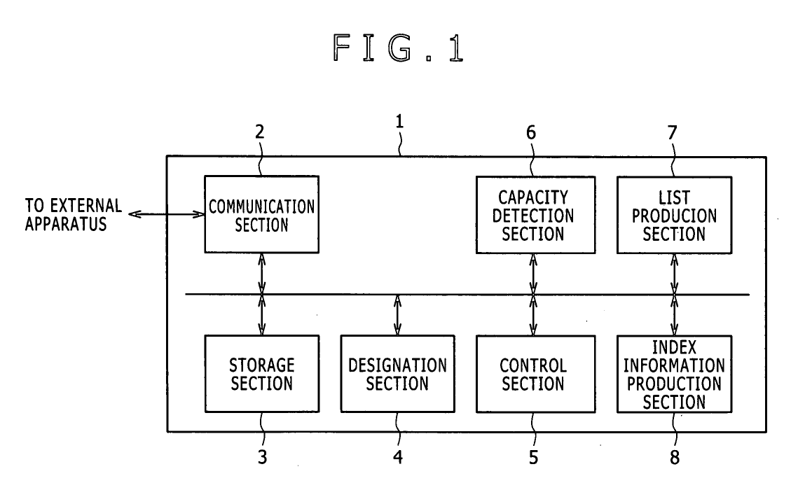

An outline of a content transfer apparatus to which the present invention is applied is described with reference to FIG. 1. Detailed description of the content transfer apparatus is given after the description of the outline.

The content transfer apparatus 1 shown in FIG. 1 includes a communication section 2 for communicating with an external apparatus such as, for example, a portable content reproduction apparatus, and a storage section 3 for storing a plurality of content data. The content transfer apparatus 1 further includes a designation section 4 for designating part or all of the content data stored in the storage section 3 as transfer content data to be transferred to the external apparatus based on the predetermined time. The content transfer apparatus 1 further includes a control section 5 for controlling the communication section 2 to transfer the transfer content data designated by the designation section 4 to the external apparatus.

If available time of the external apparatus is set typically by a user of the content transfer apparatus 1, then the content transfer apparatus 1 can transfer content data whose reproduction time corresponds to the available time to the external apparatus. Consequently, an amount of content data as much as possible can be transferred to and stored into the external apparatus without transferring an excessive amount of useless content data with respect to the available time.

The content transfer apparatus 1 further includes a capacity detection section 6 for detecting the storage capacity and the free capacity of the external apparatus. Thus, the content transfer apparatus 1 can designate transfer content data from within the storage section 3 based on time set in advance and the free capacity detected by the capacity detection section 6.

The content transfer apparatus 1 further includes a list production section 7 for producing a transfer list indicative of transfer content data. The content transfer apparatus 1 thus transfers the transfer content data based on the transfer list.

The content transfer apparatus 1 further includes an index information production section 8 for producing index information for presenting the substance of content data to the user so as to be confirmed by the user. The content transfer apparatus 1 adds the index information produced by the index information production section 8 to content data and stores the content data together with the index information.

1-2. Configuration of the Content Transfer System

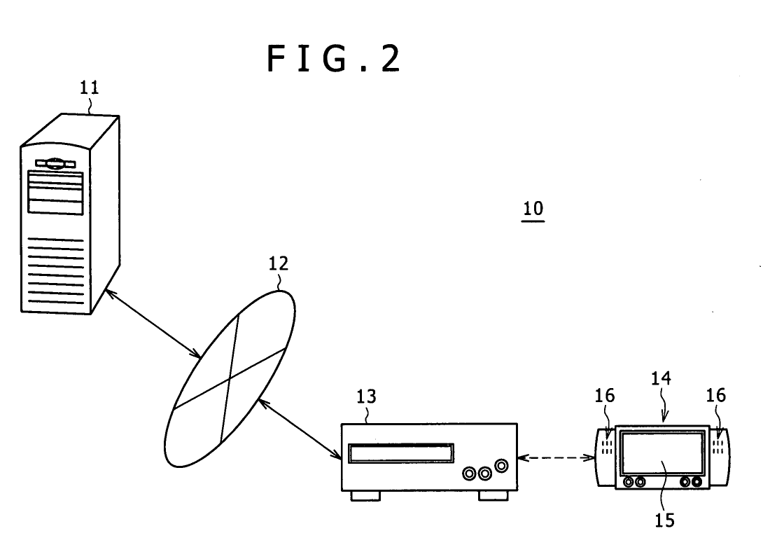

Referring now to FIG. 2, a content transfer system is shown and generally denoted by 10. In the content transfer system 10, data of a content including video and audio data (such data may be hereinafter referred to simply as content data) are distributed from a content providing server 11 through a network 12. The data are received by and stored into and retained by a content reproduction terminal 13. Then, if a portable content reproduction apparatus 14 is connected to the content reproduction terminal 13, then the content data stored and retained in the content reproduction terminal 13 are transferred to the portable content reproduction apparatus 14 so as to be stored and retained by the portable content reproduction apparatus 14. Then, for example, if the portable content reproduction apparatus 14 is disconnected from the content reproduction terminal 13 and is operated for reproduction by the user, then an image (still image or moving image) and sound based on the content data are outputted. In particular, the image (still image or moving image) is outputted from a display section 15 in the form of a liquid crystal display unit and the sound is outputted from a sound outputting section 16 in the form of a speaker. Both of the display section 15 and the sound outputting section 16 are provided on an apparatus body of the portable content reproduction apparatus 14.

1-3. Configuration of the Content Providing Server, Content Reproduction Terminal and Portable Content Reproduction Apparatus

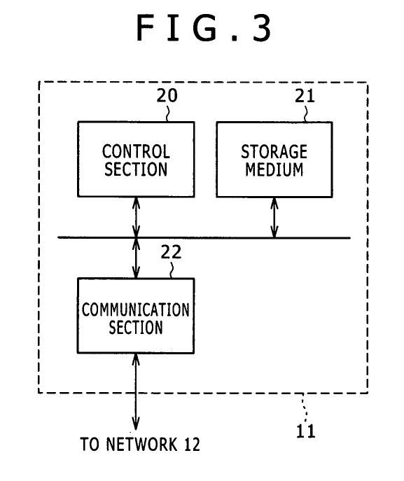

Now, the configuration of the content providing server 11, content reproduction terminal 13 and portable content reproduction apparatus 14 is described in order. First, the configuration of the content providing server 11 is described with reference to FIG. 3. The content providing server 11 includes a storage medium 21 which may be a storage device such as a hard disk unit and stores variable programs and a plurality of content data. The content providing server 11 further includes a control section 20 which controls the entire content providing server 11 in accordance with a program read out from the storage medium 21.

The content providing server 11 further includes a communication section 22. Thus, if a distribution requesting signal representative of a request for distribution of a content is received, for example, from the content reproduction terminal 13 on the network 12 through the communication section 22, then the control section 20 reads out content data corresponding to the content of the request from the storage medium 21 in response to the distribution requesting signal. Then, the control section 20 transmits the read out content data to the content reproduction terminal 13 on the network 12 through the communication section 22. In this manner, the content providing server 11 provides a content to the content reproduction terminal 13 in accordance with a request from the content reproduction terminal 13.

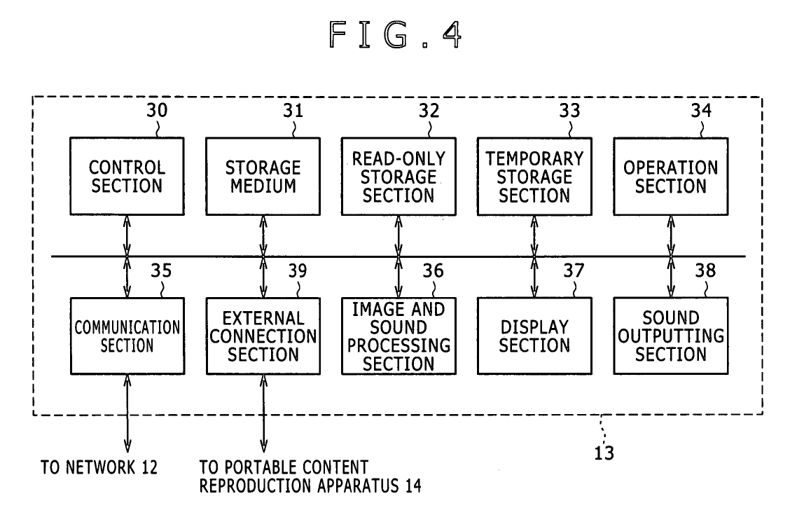

Now, the configuration of the content reproduction terminal 13 is described with reference to FIG. 4. The content reproduction terminal 13 includes a storage medium 31 which is a storage device such as a hard disk unit and a read-only storage section 32 which may be a ROM (Read Only Memory) or the like. The content reproduction terminal 13 further includes a control section 30 which controls the entire content reproduction terminal 13 and executes various processes in accordance with a program read out from the storage medium 31. The content reproduction terminal 13 further includes a temporary storage section 33 which may be a RAM (Random Access Memory) and into which data and programs handled in the processes of the control section 30 are stored by the control section 30 as occasion demands.

In particular, the control section 30 recognizes that an acquisition operation for a content to be distributed from the content providing server 11 on the network 12 is performed through an operation section 34 by the user. In response to the recognized acquisition operation, the control section 30 transmits a distribution requesting signal to the content providing server 11 on the network 12 through a communication section 35. Then, the control section 30 receives content data transmitted thereto from the content providing server 11 in response to the distribution requesting signal through the communication section 35 and stores the received content data into the storage medium 31.

Further, if the control section 30 recognizes that a reproduction operation for a content is performed through the operation section 34, then it reads out content data from the storage medium 31 and inputs the read out content to an image and sound processing section 36. The image and sound processing section 36 performs a predetermined image and sound process for the content data under the control of the control section 30 to acquire an image signal and a sound signal. Then, the control section 30 controls a display section 37 to display an image based on the image signal and controls a sound outputting section 38 to output sound based on the sound signal (that is, reproduce the content).

Further, if the portable content reproduction apparatus 14 is connected to the content reproduction terminal 13 through an external connection section 39, then the control section 30 automatically designates content data to be transferred to the portable content reproduction apparatus 14 (such data are hereinafter referred to as transfer content data) from within the storage medium 31. Then, the control section 30 transfers the designated transfer content data to the portable content reproduction apparatus 14 through the external connection section 39. It is to be noted that how to designate transfer content data is hereinafter described.

In this manner, the content reproduction terminal 13 acquires content data from the content providing server 11 and stores the content data on the storage medium 31. Then, the content reproduction terminal 13 reproduces an image and sound (that is, a content) based on the content data stored in the storage medium 31. Further, the content reproduction terminal 13 transfers the content data stored in the storage medium 31 to the portable content reproduction apparatus 14.

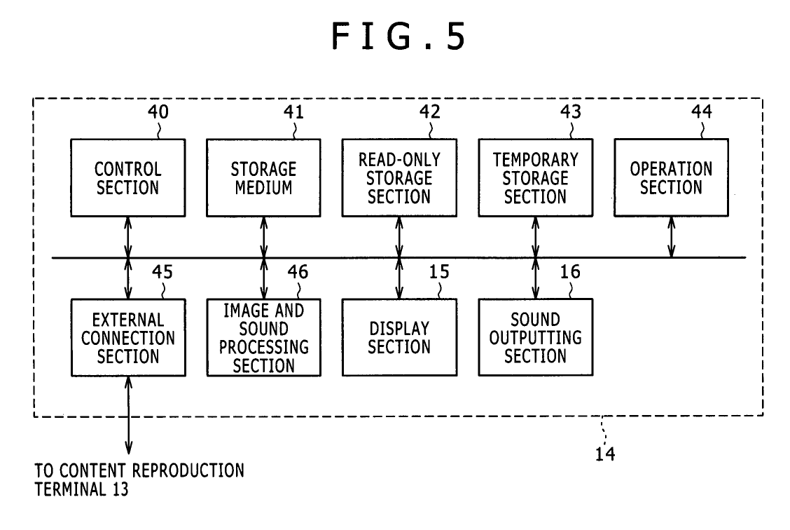

Now, the configuration of the portable content reproduction apparatus 14 is described with reference to FIG. 5. The portable content reproduction apparatus 14 includes a storage medium 41 which may be a storage device such as a hard disk unit and a read-only storage section 42 which may be a ROM. The portable content reproduction apparatus 14 further includes a control section 40 which controls the entire portable content reproduction apparatus 14 and executed various processes in accordance with a program read out from the storage medium 41 or the read-only storage section 42. The portable content reproduction apparatus 14 further includes a temporary storage section 43 which may be a RAM into which data and programs handled in the processes are stored as occasion demands. Further, an apparatus ID with which the portable content reproduction apparatus 14 can be identified is written into the read-only storage section 42 when the portable content reproduction apparatus 14 is shipped. Further, the portable content reproduction apparatus 14 stores content data transferred thereto from the content reproduction terminal 13 through an external connection section 45 into the storage medium 41.

Then, if the control section 40 recognizes that the portable content reproduction apparatus 14 is disconnected from the content reproduction terminal 13 and a reproduction operation of a content is performed through an operation section 44, then it reads out content data from the storage medium 41. The section 40 inputs the read out content data to an image and sound processing section 46 in response to the recognition. The image and sound processing section 46 performs a predetermined image and sound process for the content data under the control of the control section 40 to acquire an image signal and a sound signal. Then, an image based on the image signal is displayed on the display section 15 while sound based on the sound signal is outputted from the sound outputting section 16 (that is, the content is reproduced).

In this manner, the portable content reproduction apparatus 14 stores content data transferred thereto from the content reproduction terminal 13 into the storage medium 41 and reproduces an image and sound (that is, a content) based on the content data stored in the storage medium 41.

1-4. Transfer of Content Data

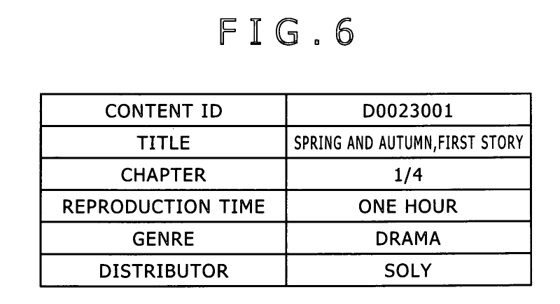

Now, transfer of content data from the content reproduction terminal 13 to the portable content reproduction apparatus 14 is described particularly. Incidentally, the storage medium 31 of the content reproduction terminal 13 stores and retains a plurality of content data received already from the content providing server 11. To each of the content data, attribute information of the content data is added. Referring to FIG. 6, the attribute information includes a content ID (for example, “D0023001”) for identification of the content data, a title (for example, “Spring and Autumn, first story”) of the content, and a chapter (For example, “¼”, hereinafter described in detail). The attribute information further includes a reproduction time period (for example, “one hour”) of the content, a genre (for example, “drama”) of the content, a distribution source (for example, “Soly”) of the content, and so forth.

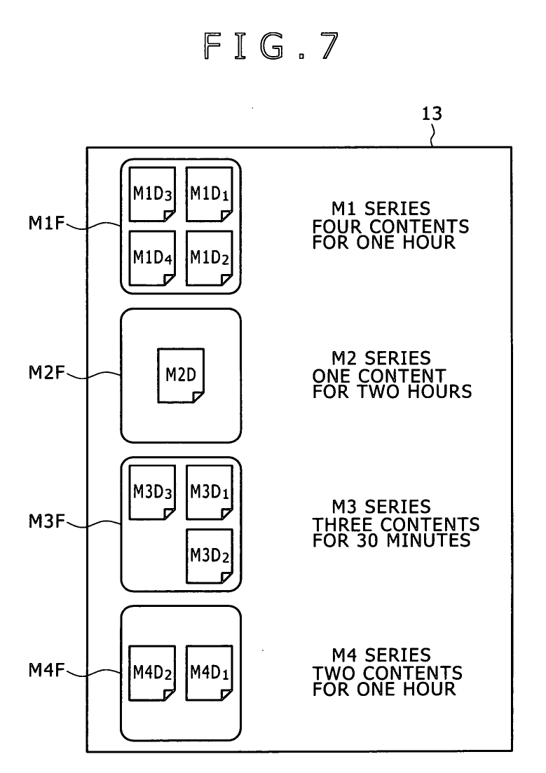

Further, the content reproduction terminal 13 stores and retains content data of the same series of contents collectively under one of folders produced for individual series as seen in FIG. 7. In this instance, the first story, second story, . . . , the part 1, part 2, the first chapter, second chapter, . . . , or the like of the same title are regarded collectively as one series. Actually, the content ID of the attribute information added to each content data is in the form of a number of eight digits such as, for example, “D0023001”. Of the number, the higher order five digits indicate a series identification number for the identification of the series, and the lower order three digits indicate a series internal number for reproduction order in the series. By the same token, the chapter of the attribute information such as, for example, “¼”, indicates a series internal number of the content with respect to the total in the series. The content reproduction terminal 13 refers to such attribute information to collect content data of contents which have the same series identification number and store and retain the content data under a folder produced for each series identification number.

As a result, for example, as seen in FIG. 7, in the storage medium 31 of the content reproduction terminal 13, content data M1D₁ (content ID “D0023001”), M1D₂ (“D0023002”), M1D₃ (“D0023003”) and M1D₄ (“D0023004”) of a series M1 which includes four contents for one hour are stored and retained under a folder M1F; content data M2D (“D0035001”) of a series M2 which includes one content for two hours is stored and retained under a file M2F; content data M3D₁ (“D0055001”), M3D₂ (“D0055002”) and M3D₃ (“D0055003”) of a series M3 which includes three contents for 30 minutes are stored and retained under a file M3F; and content data M4D, (content ID “D0101001”) and M4D₂ (“D0101002”) of a series M4 which includes two contents for one hour are stored and retained under a folder M4F.

Further, the content reproduction terminal 13 can arbitrarily set the available time of the portable content reproduction apparatus 14 as preset time. Furthermore, when the portable content reproduction apparatus 14 is connected to the content reproduction terminal 13 through the external connection section 39, the content reproduction terminal 13 can detect the capacity and the free capacity of the storage medium 41 of the portable content reproduction apparatus 14. The content reproduction terminal 13 can recognize storable time indicative of for what hours content data can be stored in the storage medium 41 of the portable content reproduction apparatus 14. The recognition in this instance is performed based on the detected free capacity of the storage medium 41 of the portable content reproduction apparatus 14 and the format of the content data stored and retained in the content reproduction terminal 13 itself.

After the content reproduction terminal 13 stores the preset time (for example, one hour) and the storable time (for example, three hours) in this manner, it designates transfer content data to be transferred to the portable content reproduction apparatus 14 from within the storage medium 31 based on the preset time and the storable time.

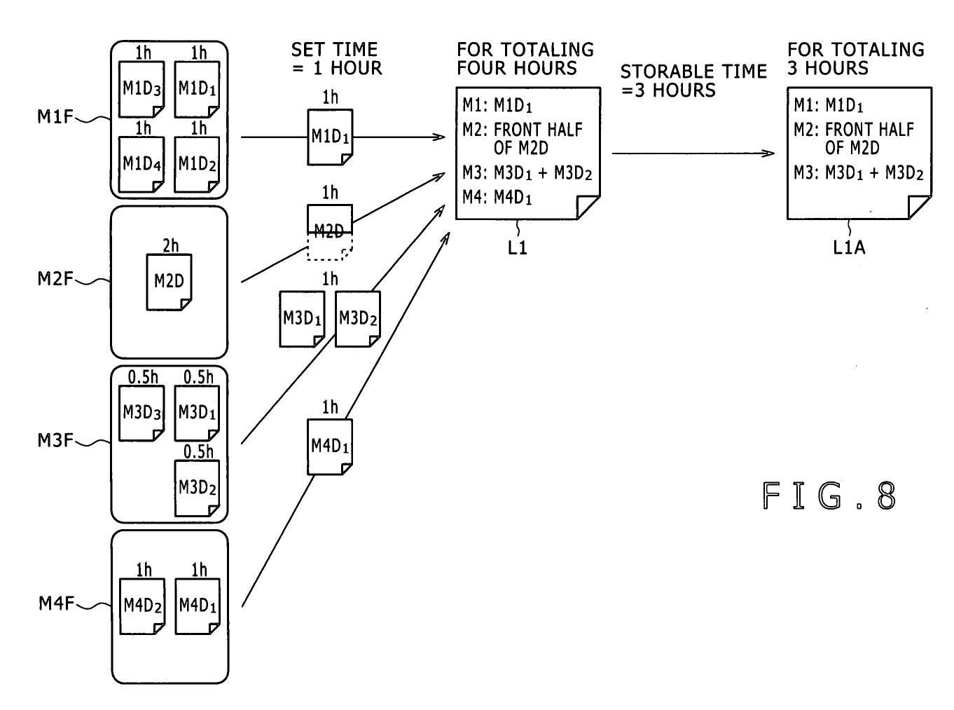

In particular, the content reproduction terminal 13 designates content data for the preset time individually from within the folders M1F, M2F, M3F and M4F (that is, for the individual series) based on the preset time (one hour) as seen in FIG. 8. Then, the content reproduction terminal 13 produces a list L1 of the designated contents. In this instance, the content reproduction terminal 13 preferentially designates, from within any folder which includes a plurality of content data for the preset time such as folders M1F to M4F, the content data in an ascending order of the reproduction number. Therefore, from within the folder M1F, the content data M1D₁ for one hour is designated and entered as content data for the preset time designated from within the series M1 into the list L1. Meanwhile, from within the folder M4F, the content data M4D₁ for one hour is designated and entered as content data for the preset time designated from within the series M4 into the list L1. Incidentally, while, in the present embodiment, content data are designated preferentially in an ascending order of the reproduction number from within any folder which includes a plurality of content data for the preset time, a content may be preferentially designated reversely in a descending order of the reproduction number. For example, if content data are designated based on the genre information, then where the genre is a drama or a movie in which contents have some continuity in story, content data are designated preferentially in an ascending order of the reproduction number. However, where the genre is news or a talk show in which contents have little continuity, the latest program should be designated preferentially. Thus, the chapter information or updating date information of contents should be referred to to designate the contents in a preferential order for each genre.

From within a folder which includes content data having time longer than the preset time such as the folder M2F, a portion of the content data from the preset time is designated from the top of the content data. Therefore, from within the folder M2F, the front half of the content data M2D (that is, a portion for one half from the top of the content data M2D) is designated. Then, this is entered as designated content data for the preset time into the list L1. Further, from within a folder which includes a plurality of content data having time shorter than the preset time like the folder M3F, a plurality of content data having reproduction time shorter than the preset time are designated in an ascending reproduction order in accordance with the preset time. Therefore, from within the folder M3F, the content data M3D₁ and M3D₂ for 30 minutes are designated, and they are entered as designated content data for the preset time into the list L1.

Thus, content data for the preset time designated for the individual series are recorded in the list L1, and the content data for the preset time for the individual series entered in the list L1 are determined as an object of transfer to the portable content reproduction apparatus 14. In the following description, the list L1 is referred to as transfer object list L1. Incidentally, in this instance, since content data for one hour are designated from within each of the four series of the series M1 to M4, four content data each for one hour, that is, content data for totaling four hours, are entered in the transfer object list L1.

After the transfer object list L1 is produced, the content reproduction terminal 13 subsequently designates transfer content data to be actually transferred from within the transfer object list L1 based on the storable time of the portable content reproduction apparatus 14. Then, the content reproduction terminal 13 produces a transfer list L1A which indicates the designated transfer content data.

In particular, since the storable time in this instance is three hours, the content reproduction terminal 13 designates three content data each for one hour, for example, from the M1 to M3 series from among the four content data each for one hour from the series M1 to M4 entered in the transfer object list L1. The designation method in this instance may be, for example, a method of designating the content data in an order listed in the transfer object list L1 or another method of designating the content data at random. The designation method may otherwise be a further method of designating the content data based on user preference information (for example, a favorite genre) of the user which is registered in advance.

After the content data of the three M1 to M3 series each for one hour are designated, the content reproduction terminal 13 adds the selected content data of the three M1 to M3 series for one hour as transfer content data to the transfer list L1A.

In this manner, the content reproduction terminal 13 automatically designates transfer content data to be transferred to the portable content reproduction apparatus 14 from within the storage medium 31 based on the preset time and the storable time. Further, the content reproduction terminal 13 produces the transfer list L1A representative of the transfer content data and stores the transfer list L1A, for example, into the temporary storage section 33. Then, the content reproduction terminal 13 reads out content data from the storage medium 31 in accordance with the transfer list L1A and transfers the content data to the portable content reproduction apparatus 14. In particular, in this instance, the content reproduction terminal 13 transfers the content data M1D₁, the front half of the content data M2D and the content data M3D₁ and M3D₂ entered in the transfer list L1A.

Although the transfer list L1A may be produced based on the preset time and the storable time as described above, the transfer list may be produced otherwise based on a set data number. For example, if transfer of two contents from each folder is designated, then two content data are added from each of the four folders M1F to M4F to the transfer list L1A. Since the folder M2F includes only one content, only the content data M2D is added to the transfer list L1A.

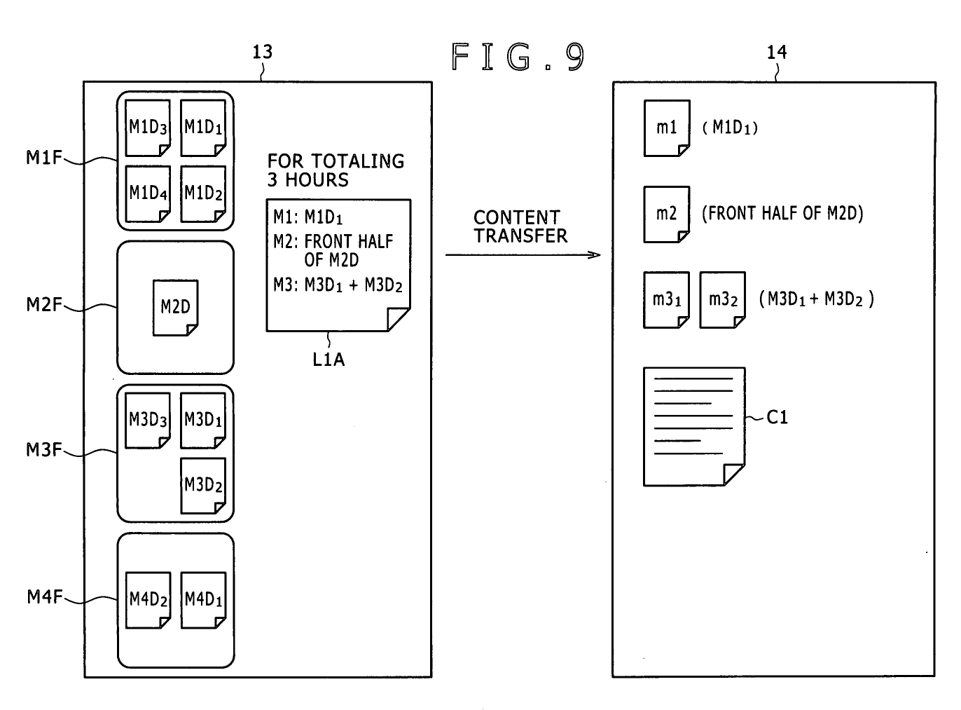

Meanwhile, as seen in FIG. 9, the portable content reproduction apparatus 14 stores and retains content data M1D₁ transferred thereto from the content reproduction terminal 13 as content data m1, the front half of the content data M2D as content data m2, the content data M3D, and M3D₂ as content data m3₁ and m3₂ into the storage medium 41. Further, the portable content reproduction apparatus 14 produces management information CI for managing the content data m1, m2, and m3₁ and m3₂ and stores and retains the management information CI into the storage medium 41.

The management information CI is list information for managing the content data m1, m2, and m3₁ and m3₂ as contents for each series. In this instance, the content data m1 for one hour are stored and retained as a content for one hour of the series M1; the content data m2 for one hour are stored and retained as a content for one hour of the series M2; and the content data m3₁ and m3₂ each for 30 minutes are stored and retained as contents for one hour of the series M3.

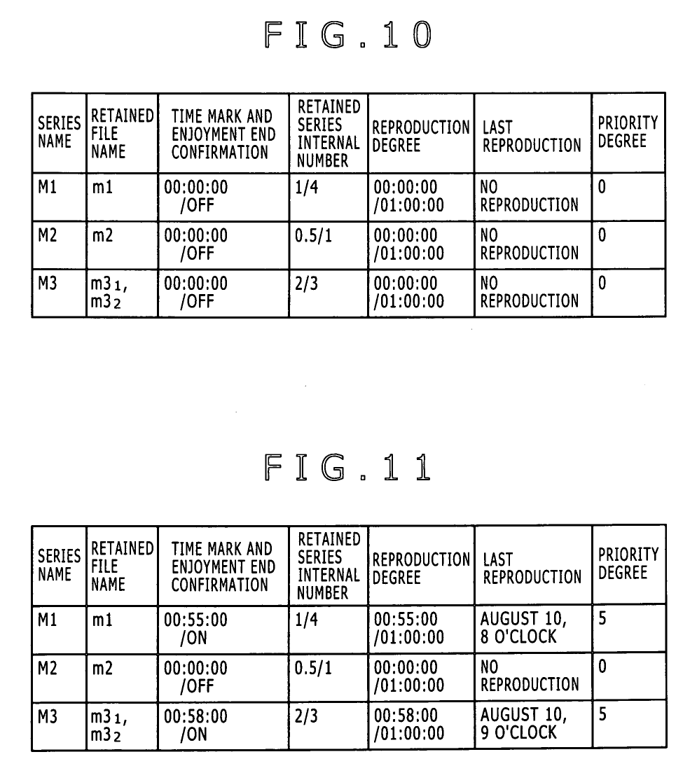

Actually, as seen in FIGS. 10 and 11, the management information CI includes a series name (for example, “M1”), and a file name (that is, a content data name, and for example, “m1”) of a content of the series. The management information CI further includes a time mark position (for example “00:55:00”) which indicates the position of a time mark applied to a point of time at which reproduction of the content is stopped as hour, minute and second, and enjoyment end confirmation representative of whether enjoyment of the content is ended (for example, “OFF” which indicates that enjoyment of the content is not ended or “ON” which indicates that enjoyment is ended). The management information CI further includes a series internal number (for example, “¼”) of the stored and retained content with respect to the total number of contents of the same series, and a reproduction degree (for example, “00:55:00/01:00:00”) which indicates by what degree the content has been reproduced as hour, minute and second. The management information CI further includes last reproduction (For example, “August 10, 8 o'clock) which indicates the date and hour at which the content was reproduced last, and a priority degree of the content (for example, one of “1” to “5” in an ascending order of the priority). Incidentally, the enjoyment end confirmation is changed into “ON” if it is designated by a user operation that enjoyment of the content is ended even if the user does not enjoy the content to the last end. Meanwhile, the priority degree is information used, for example, to determine the preferential order for transfer of a content.

The management information CI of FIG. 10 represents a state immediately after content data transferred from the content reproduction terminal 13 to the portable content reproduction apparatus 14 are stored as content data m1, m2, m3₁ and m3₂ by the portable content reproduction apparatus 14. In particular, in this instance, since none of the contents of the series is reproduced as yet, the time mark position is “00:00:00”; the reproduction degree is “00:00:00/01:00:00”; the last reproduction is “not reproduced”; and the priority degree is “0”.

In contrast, the management information CI of FIG. 11 represents a state after the portable content reproduction apparatus 14 is thereafter disconnected from the content reproduction terminal 13 and then reproduces the content data m1, m3₁ and m3₂ from among the content data m1, m2, m3₁ and m3₂ and it is designated by the user that enjoyment of the contents is ended based on the content data m1, m3₁ and m3₂. In other words, the management information CI of FIG. 11 represents a state after it is designated that the content of the series M1 and the contents of the series M3 have been reproduced and enjoyed completely. In short, in this instance, the time mark position of the time mark on the content of the series M1 is updated, for example, to “00:55:00”; the enjoyment end confirmation to “ON”; the reproduction degree, for example, to “00:55:00/01:00:00”; the last reproduction, for example, to “August 10, 8 o'clock”; and the priority degree to “5”. Further, the time mark position of the time mark on the contents of the series M3 is updated, for example, to “00:58:00”; the enjoyment end confirmation to “ON”; the reproduction degree, for example, to “00:58:00/01:00:00”; the last reproduction, for example, to “August 10, 9 o'clock”; and the priority degree to “5”.

From the management information CI, the portable content reproduction apparatus 14 confirms, with regard to the content of each series, at which point of time reproduction is stopped; whether or not enjoyment is ended; what is the series internal number; to which degree reproduction has proceeded; when the content was reproduced last; and so forth.

Further, the management information CI is transferred from the portable content reproduction apparatus 14 to the content reproduction terminal 13 when the portable content reproduction apparatus 14 is connected to the content reproduction terminal 13. Then, the content reproduction terminal 13 designates, based on the preset time and the storable time described hereinabove and the management information CI, a content to be deleted from the portable content reproduction apparatus 14 and a transfer content to be transferred to the portable content reproduction apparatus 14. Then, the content reproduction terminal 13 performs deletion and transfer (hereinafter described in detail) of the designated contents.

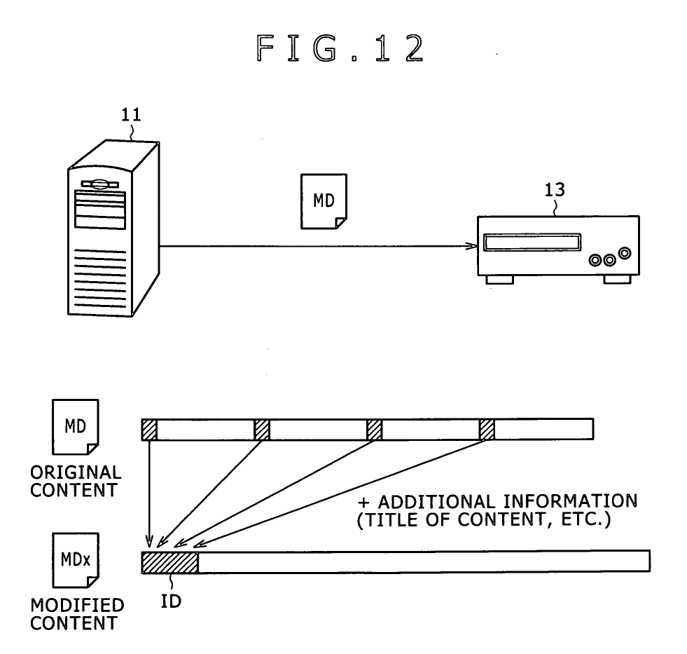

Further, when the content reproduction terminal 13 receives content data MD from the content providing server 11 as seen in FIG. 12, it produces index information ID for allowing the user to confirm the substance of a content based on the content data MD from the content data MD. Then, the content reproduction terminal 13 adds the index information ID to the top (for example, a header part) of the content data MD.

Actually, the content reproduction terminal 13 divides the received content data MD, for example, into four portions and reads out the content data for several seconds individually from the top of the divisional portions. Then, the content reproduction terminal 13 joins the four read out content data for several seconds together and adds additional information such as the title and the genre of the content obtained from attribute information of the content data MD to the joined content data to produce index information ID. Then, the content reproduction terminal 13 adds the index information ID to the top of the content data MD to produce content data MDx and then stores and retains the content data MDx into the storage medium 31.

In other words, to the top portion of each of the content data M1D₁, M1D₂, M1D₃, M1D₄, M2D, M3D₁, M3D₂, M3D₃, M4D₁ and M4D₂ described hereinabove stored and retained in the storage medium 31 of the content reproduction terminal 13, index information ID is added. Further, it is a matter of course that, where the content data are transferred, index information ID is added to the top portion of each of the content data m1, m2, m3₁ and m3₂ stored and retained in the storage medium 41 of the portable content reproduction apparatus 14.

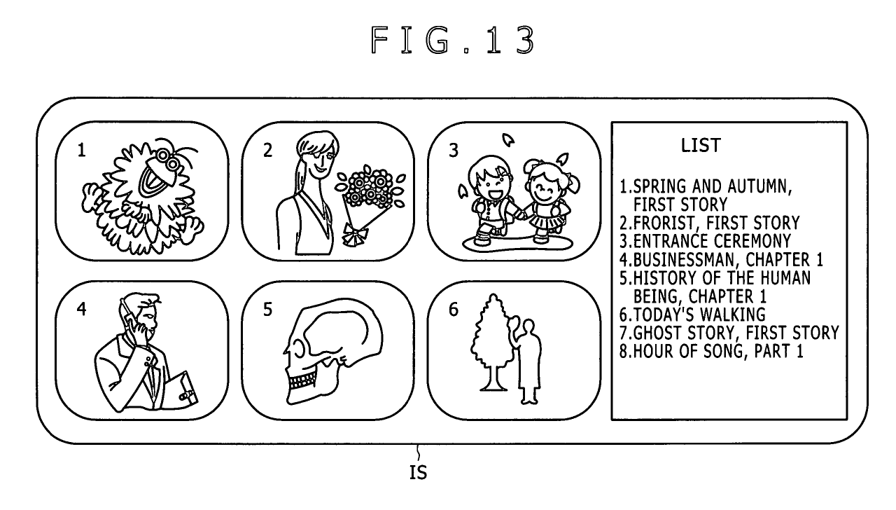

As a result, for example, as shown in FIG. 13, the portable content reproduction apparatus 14 reads the index information ID of the content data m1, m2, m3₁ and m3₂ and displays part of images based on the index information ID as a list of thumbnail images. Further, the portable content reproduction apparatus 14 produces a list of the titles of contents included in the index information ID to produce a table display screen IS for displaying the titles in a table and displays the table display screen IS on the display section 15. Incidentally, the table display screen IS of FIG. 13 is an example of a display screen when a plurality of content data are stored and retained in the portable content reproduction apparatus 14 in addition to the content data m1, m2, m3₁ and m3₂.

Consequently, the portable content reproduction apparatus 14 allows the user to confirm the substance of contents automatically transferred thereto from the content reproduction terminal 13 and stored and retained therein without especially reproducing the contents. Further, at this time, the portable content reproduction apparatus 14 allows the user to confirm the substance of the contents more intuitively by displaying not only the titles of the contents but also part of images of the contents on the display section 15.

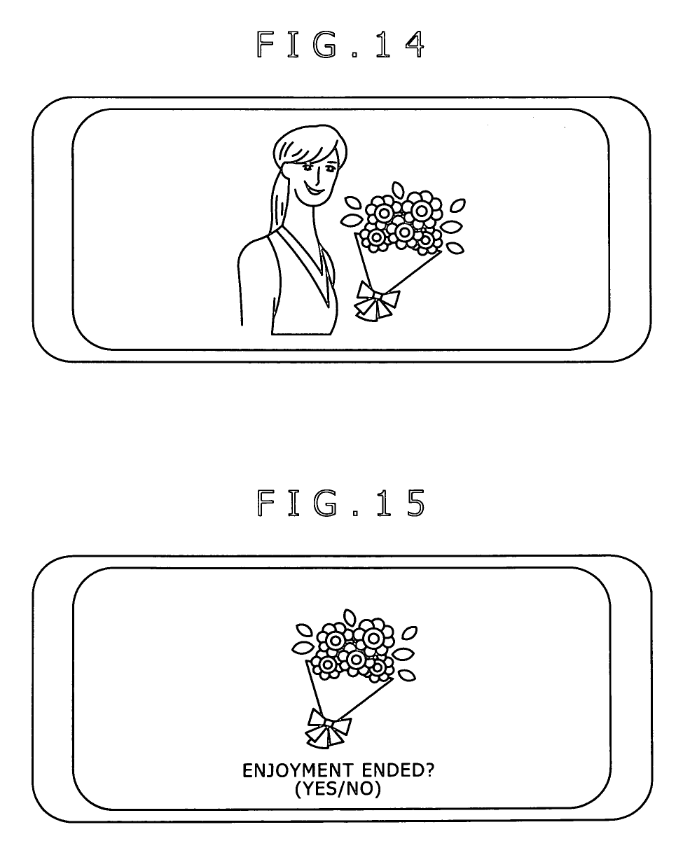

Then, if the user selects a content with reference to the thumbnail images or the list on the table display screen IS, then the portable content reproduction apparatus 14 reads out content data of the content and displays an image based on the content data on the display section 15 in place of the table display screen IS as seen in FIG. 14. Further, the portable content reproduction apparatus 14 outputs sound based on the content data from the sound outputting section 16. The portable content reproduction apparatus 14 reproduces the content in this manner.

After the reproduction of the content is started in this manner, if a stopping operation is performed by the user, then the portable content reproduction apparatus 14 applies a time mark at the stopping point of the content having been reproduced. Further, the portable content reproduction apparatus 14 displays, in response to the reproduction degree of the content, a message for urging the user to confirm whether or not the enjoyment of the content having been reproduced is ended. The portable content reproduction apparatus 14 simultaneously displays choices for the response to the message (for example, “Yes” indicating that the enjoyment is ended and “No” indicating that the enjoyment is not ended) on the display section 15 as seen in FIG. 15.

Then, if the choice “Yes” is selected by a user operation, then the portable content reproduction apparatus 14 updates the time mark position of the management information CI for the content and sets the enjoyment end confirmation to “ON”. Further, the portable content reproduction apparatus 14 updates the reproduction degree with the period of time taken for the reproduction to the stopping point and further updates the last reproduction with the date and hour at the time. Furthermore, the portable content reproduction apparatus 14 changes the priority degree, for example, from “0” to “5”. On the other hand, if the other choice “No” is selected, then the portable content reproduction apparatus 14 updates the time mark position of the management information CI for the content and updates the reproduction degree with the period of time taken for the reproduction up to the stopping point. Further, the display section 15 updates the last reproduction with the date and hour at this time. In this manner, the portable content reproduction apparatus 14 updates the management information CI at any time in response to reproduction of a content.

1-5. Processing Procedures

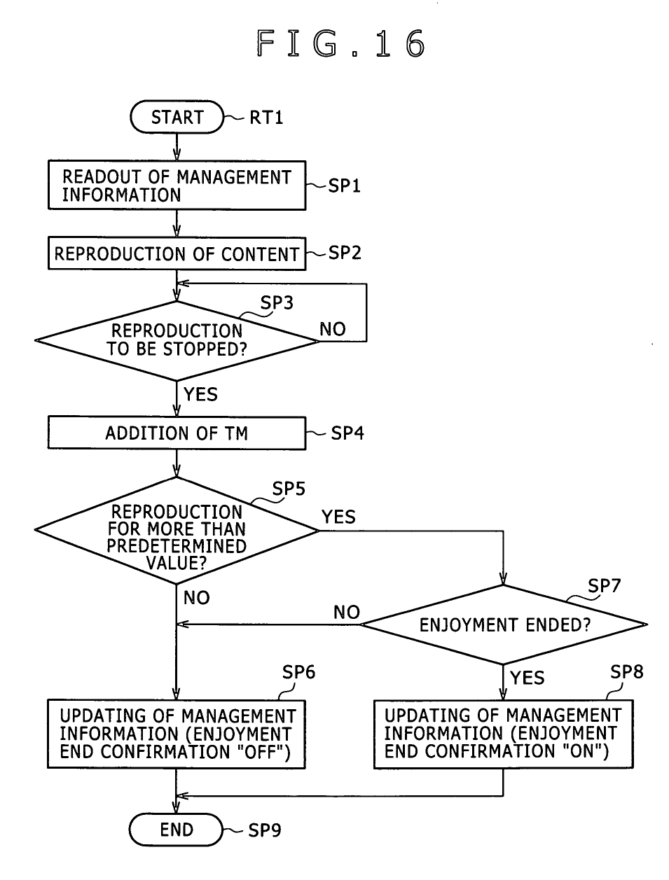

Now, the procedures of a content transfer process from the content reproduction terminal 13 to the portable content reproduction apparatus 14 and a content reproduction process in the portable content reproduction apparatus 14 are described. Here, for the convenience of description, the content reproduction process in the portable content reproduction apparatus 14 is described first with reference to the flow chart of FIG. 16. It is to be noted that, in this instance, it is assumed that the portable content reproduction apparatus 14 is in a state wherein it is disconnected from the content reproduction terminal 13. Also it is assumed that the storage medium 41 has stored therein the content data transferred thereto from the content reproduction terminal 13 by the content transfer process hereinafter described.

If the control section 40 of the portable content reproduction apparatus 14 recognizes that a reproduction operation of a content is performed through the operation section 44, then it starts a content reproduction processing procedure RT1 and advances the processing to step SP1. At step SP1, the control section 40 reads out the management information CI from the storage medium 41, and advances the processing to next step SP2. At step SP2, the control section 40 reads out content data of the content designated by the reproduction operation and outputs an image and sound based on the content data so that reproduction of the content is started. Then, the processing advances to next step SP3.

At step SP3, the control section 40 waits for a stopping operation by the user, and if it recognizes that a stopping operation is performed, then it stops the reproduction of the content and advances the processing to step SP4. At step SP4, the control section 40 adds a time mark to a stopping point of time of the content having been reproduced and advances the processing to next step SP5. At step SP5, the control section 40 decides whether or not the reproduction time of the content till the stopping point of time is, for example, 90% or more of the reproduction time of the content.

If a negative result is obtained at step SP5, then this represents that only less than 90% of the content are reproduced as yet. At this time, the processing advances to step SP6, at which the control section 40 updates the reproduction degree and the last reproduction of the content, which has been reproduced, included in the management information CI in response to the stopping point of time of the reproduced content. Further, the control section 40 updates the time mark position of the content included in the management information CI in response to the position of the time mark added at step SP4. Then, the processing advances to ending step SP9, at which the content reproduction processing procedure RT1 is ended.

On the other hand, if an affirmative result is obtained at step SP5, then this represents that 90% or more of the content are reproduced. At this time, the processing advances to step SP7, at which the control section 40 controls the display section 15 to display a massage for the confirmation of whether or not the enjoyment of the content having been reproduced is ended and choices (“Yes” and “No”) to the message. Thereafter, the control section 40 decides whether or not one of the choices “Yes” is selected by an operation of the user.

If a negative result is obtained at step SP7, then this represents that it is designated by the user that the user does not end to enjoy the content having been reproduced. At this time, the processing advances to step SP6, at which the control section 40 updates the management information CI. Then, the processing advances to step SP9, at which the content reproduction processing procedure RT1 is ended.

On the other hand, if an affirmative result is obtained at step SP7, then this represents that it is designated by the user that the user ends to enjoy the content having been reproduced. At this time, the processing advances to step SP8, at which the control section 40 updates the reproduction degree and the last reproduction of the reproduced content included in the management information CI in response to the stopping point of time of the reproduced content. Further, the control section 40 updates the time mark position of the reproduced content included in the management information CI in response to the position of the time mark added at step SP4. Further, the control section 40 changes the enjoyment end confirmation of the reproduced content to “ON” and changes the priority degree, for example, from “0” to “5”. Then, the processing advances to ending step SP9, at which the content reproduction processing procedure RT1 is ended.

In accordance with such a content reproduction processing procedure RT1 as described above, the control section 40 controls to reproduce a content and update the management information CI in response to the stopping point of time of the content having been reproduced.

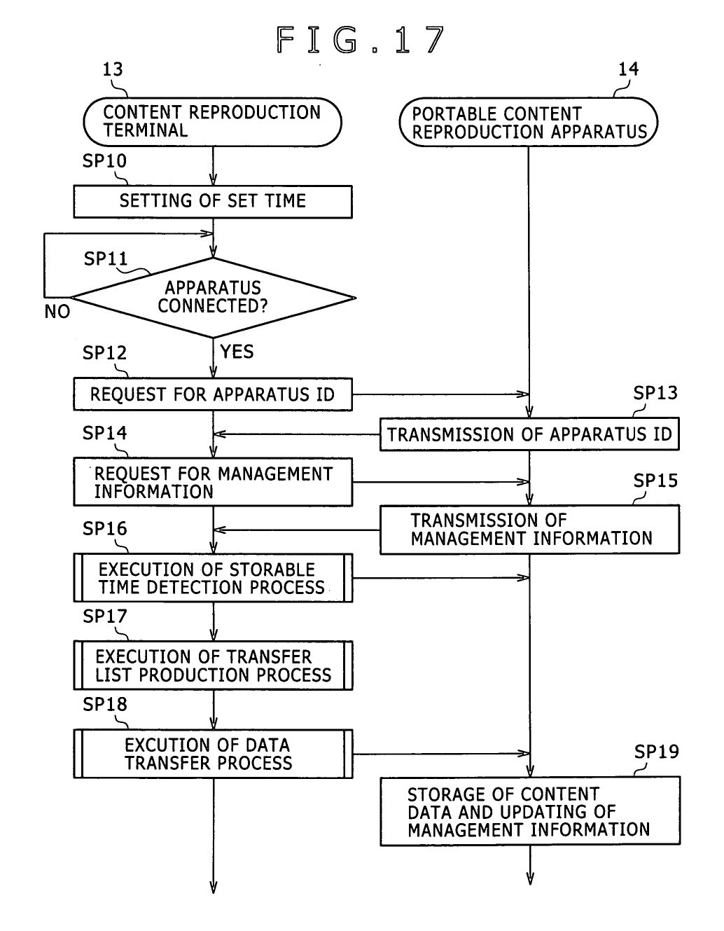

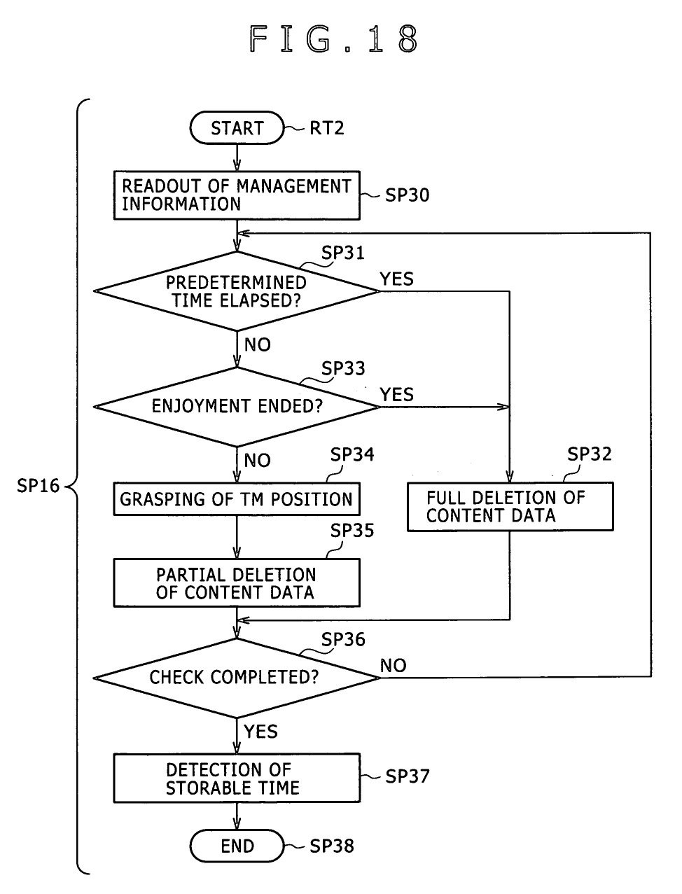

Now, a procedure of the content transfer process from the content reproduction terminal 13 to the portable content reproduction apparatus 14 is described with reference to a sequence chart of FIG. 17 and flow charts of FIGS. 18, 19 and 20. As seen in FIG. 17, at step SP10, the control section 30 of the content reproduction terminal 13 urges the user to input use time of the portable content reproduction apparatus 14 through the operation section 34 and sets the inputted use time as pre-set time. Thereafter, the processing advances to step SP1. In this instance, the preset time is set, for example, for each apparatus ID of the portable content reproduction apparatus 14.

At step SP11, the control section 30 waits that the portable content reproduction apparatus 14 is connected to the content reproduction terminal 13 through the outside connector 39. Then, if it is recognized that the portable content reproduction apparatus 14 is connected, then the processing advances to next step SP12. At step SP12, the control section 30 transmits an apparatus ID requesting signal for requesting transmission of an apparatus ID to the portable content reproduction apparatus 14 connected through the outside connector 39.

The apparatus ID requesting signal transmitted from the content reproduction terminal 13 connected to the portable content reproduction apparatus 14 is received by the portable content reproduction apparatus 14 through the outside connector 45. Then, at step SP13, the control section 40 of the portable content reproduction apparatus 14 reads out the apparatus ID from the read only storage section 42 in response to the apparatus ID requesting signal and transmits the read out apparatus ID to the content reproduction terminal 13.

The apparatus ID transmitted from the portable content reproduction apparatus 14 is received by the content reproduction terminal 13. Thus, the control section 30 of the content reproduction terminal 13 stores the apparatus ID, for example, into the temporary storage section 33. Thereafter, at step SP14, the control section 30 transmits a management information requesting signal for requesting transfer of management information CI to the portable content reproduction apparatus 14.

The management information requesting signal transmitted from the content reproduction terminal 13 is received by the portable content reproduction apparatus 14. Thus, at step SP15, the control section 40 of the portable content reproduction apparatus 14 reads out the management information CI from the storage medium 41 in response to the management information requesting signal and transfers the read out management information CI to the content reproduction terminal 13.

The management information CI transmitted from the portable content reproduction apparatus 14 is received by the content reproduction terminal 13. Thus, the control section 30 of the content reproduction terminal 13 stores the management information, CI, for example, into the temporary storage section 33. Thereafter, at step SP16, the control section 30 executes a storable time detection process for detecting storable time of the storage medium 41 included in the portable content reproduction apparatus 14.

Here, a procedure of the storable time detection process executed at step SP16 is described with reference to the flow chart of FIG. 18. After the storable time detection processing procedure RT2 is started, the control section 30 of the content reproduction terminal 13 reads out the management information CI from the temporary storage section 33 at step SP30. Then, the processing advances to next step SP31. At step SP31, the control section 30 first refers to the first row of the management CI and compares the date and hour of the last reproduction of the first row and the date and hour at present to decide whether or not, for example, 24 hours or more elapse after the date and hour of the last reproduction.

If an affirmative result is obtained at step SP31, then this represents that one day or more elapse after the content described in the first row was reproduced last. At this time, the control section 30 determines that the user will not enjoy the content described in the first row any more, and the processing advances to step SP32. At step SP32, the control section 30 deletes the content data corresponding to the file name in the first row of the management information CI from the storage medium 41 of the portable content reproduction apparatus 14 connected through the outside connector 39 to increase the free capacity of the storage medium 41. Then, the processing advances to step SP36. It is to be noted that, also where the date and hour of the last reproduction is “no reproduction”, an affirmative result is obtained at step SP31 and the corresponding content data are deleted.

On the other hand, if a negative result is obtained at step SP31, then this represents that one day or more do not elapse after the content described in the first row was reproduced last. At this time, the control section 30 determines that there is the possibility that the user may further enjoy the content described in the first row, and the processing advances to step SP33. At step SP33, the control section 30 decides whether or not the enjoyment end confirmation of the first row is “ON”.

If an affirmative result is obtained at step SP33, then this represents that it is designated by the user that the user ends to enjoy the content described in the first row. At this time, the processing advances to step SP32, at which the control section 30 deletes content data corresponding to the file name in the first row of the management information CI from the storage medium 41 of the portable content reproduction apparatus 14 connected through the outside connector 39 to increase the free capacity of the storage medium 41. Thereafter, the processing advances to step SP36.

On the other hand, if a negative result is obtained at step SP33, then this represents that the user does not end to enjoy the content described in the first row. At this time, the control section 30 advances the processing to step SP34. At step SP34, the control section 30 confirms the time mark position of the first row, and the processing advances to next step SP35. At step SP35, the control section 30 deletes that portion of content data corresponding to the file name in the first row of the management information CI stored in the storage medium 41 of the portable content reproduction apparatus 14 which precedes to the time mark position (that is, a portion of the content data whose reproduction is ended) based on the time mark position to increase the free capacity of the storage medium 41. Thereafter, the processing advances to next step SP36.

At step SP36, the control section 30 decides whether or not the processes from step SP31 to step SP35 are ended for all rows of the management information CI. Here, if the management information CI has, for example, three rows of the series M1 to M3 as shown in FIG. 11, then after the processes for the first row are ended, the control section 30 obtains a negative result at step SP36 and returns the processing to step SP31. Thereafter, the control section 30 starts the processes for the second row. Then, after the processes are successively performed for the second and third rows until the processing for the third row (that is, the last row) is ended, an affirmative result is obtained at step SP36, and the processing advances to step SP37.

At step SP37, the control section 30 detects the free capacity of the storage medium 41 included in the portable content reproduction apparatus 14 and detects storable time of the portable content reproduction apparatus 14 based on the detected free capacity and the format of the content data stored by the content reproduction terminal 13. Then, the processing advances to ending step SP38, at which the storable time detection process procedure RT2 is ended.

In accordance with such a storable time detection process procedure RT2, the control section 30 deletes unnecessary content data and that portion of content data whose reproduction is ended from among the content data stored in the storage medium 41 included in the portable content reproduction apparatus 14 to increase the free capacity of the storage medium 41. Thereafter, the control section 30 detects storable time based on the increased free capacity.

After the storable time detection process is executed at step SP16 (FIG. 17) in such a manner as described above, the control section 30 advances the processing to next step SP17. At step SP17, the control section 40 executes a transfer list production process for producing a transfer list L1A which indicates transfer content data to be transferred to the portable content reproduction apparatus 14.

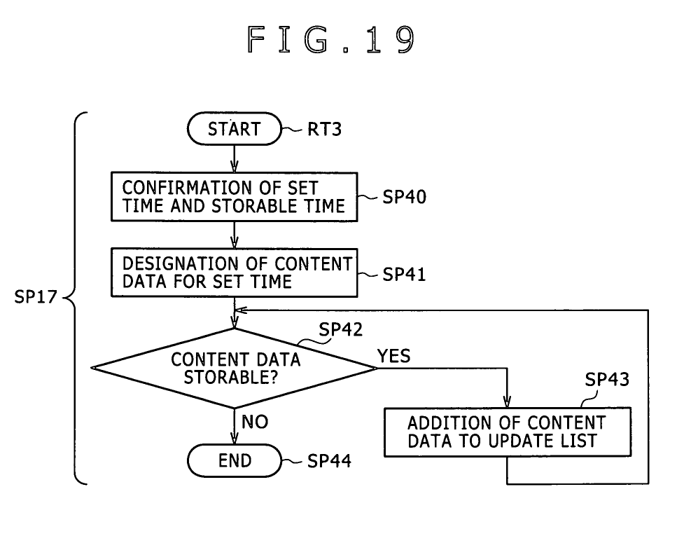

Here, a procedure of the transfer list production process to be executed at step SP17 is described with reference to the flowchart shown in FIG. 19. After the transfer list production processing procedure RT3 is started, the control section 30 of the content reproduction terminal 13 confirms, at step SP40, the preset time set at step SP10 and the storable time detected at step SP16. Then, the processing advances to next step SP41. At step SP41, the control section 30 designates the content data for the preset time from within the folders M1F, M2F, M3F and M4F of the storage medium 41 based on the preset time to produce a transfer object list L1 as seen in FIG. 8.

Actually, the content data for the preset time are designated from within the folders M1F, M2F, M3F and M4F at step SP41 in the following manner. In particular, the control section 30 recognizes, based on the enjoyment end confirmation and the retained series internal number of the management information CI acquired from the portable content reproduction apparatus 14, the series internal number, which is stored in the storage medium 41 of the portable content reproduction apparatus 14, of the content data (the data themselves were deleted in the storable time detection process described above) whose enjoyment by the user is ended. Then, the control section 30 designates content data having a series internal number next to the recognized series internal number. In particular, for example, if content data of the series internal number “1” of the series M1 are stored and retained in the storage medium 41 of the portable content reproduction apparatus 14 whereas enjoyment of the content data by the user is ended as seen in FIG. 11, then the control section 30 decides that the content data to be designated from within the folder M1F corresponding to the series M1 is content data having the series internal number “2”. Thus, the control section 30 designates the content data M1D₂ having the series internal number “2” from within the folder M1F. Further, since enjoyment by the user of content data having a series internal number “0.5” of the series M2 is not ended as yet, the control section 30 does not designate any content data from within the folder M2F corresponding to the series M2.

After the content data for the preset time are designated to produce the transfer object list L1 in such a manner as described above, the control section 30 advances the processing to next step SP42. At step SP42, the control section 30 decides based on the storable time whether or not the content data for the preset time described in the first row of the transfer object list L1 can be stored into the portable content reproduction apparatus 14. Here, if the storable time is three hours and the preset time is one hour, then it is decided that the content data for the preset time described in the first row can be stored into the portable content reproduction apparatus 14. Therefore, the control section 30 obtains an affirmative result at step SP42, and the processing advances to next step SP43.

At step SP43, the control section 30 adds the content data for the preset time (one hour) described in the first row of the transfer object list L1 to the transfer list L1A to update the transfer list L1A, and recognizes the remaining time (at this time, three hours-one hour) of the storable time. Thereafter, the processing returns to step SP42.

Then, the control section 30 repetitively performs the processes at steps SP42 to SP43 until the remaining time of the storable time becomes less than the preset time (one hour) so that the content data for the preset time (one hour) described in the second, third and . . . rows of the transfer object list L1 are added one by one to the transfer list L1A. Then, if the remaining time becomes less than the preset time (one hour), then, since the content data for the preset time (one hour) cannot be stored into the portable content reproduction apparatus 14 any more, a negative result is obtained at step SP42. Thereafter, the processing advances to ending step SP44, at which the transfer list production processing procedure RT3 is ended.

In particular, where the storable time is three hours, the remaining time of the storable time becomes less than the preset time (one hour) at the point of time at which the three content data for the preset time (one hour) described in the first, second, third rows of the transfer object list L1 are added to the transfer list L1A. Therefore, the three content data for the preset time (one hour), that is, the content data for totaling three hours, are described in the transfer list L1A.

In accordance with such a transfer list production processing procedure RT3 as described above, the control section 30 produces the transfer list L1A which indicates the transfer content data to be transferred to the portable content reproduction apparatus 14 based on the preset time and the storable time.

After the transfer list production process is executed at step SP17 (FIG. 17) in such a manner as described above, the control section 30 advances the processing to next step SP18. At step SP18, the control section 30 executes a data transfer process for transferring the content data to the portable reproduction apparatus 14 based on the transfer list L1A.

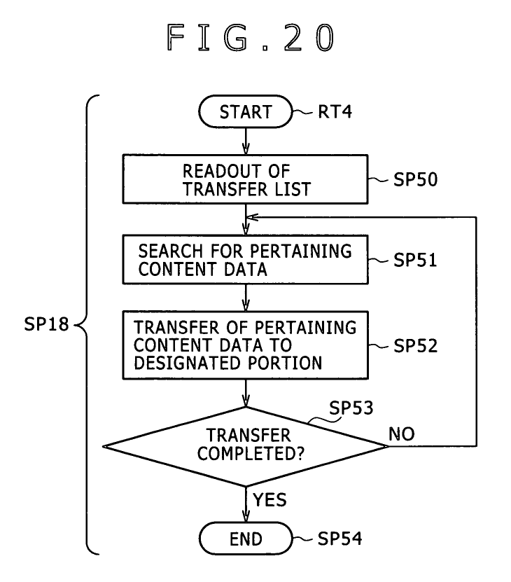

Here, the procedure of the data transfer process to be executed at step SP18 is described with reference to a flow chart in FIG. 20. If a data transfer processing procedure RT4 is started, then the control section 30 of the content reproduction terminal 13 reads out the transfer list L1A from the temporary storage section 33 at step SP50. Then, the processing advances to next step SP51.

At step SP51, the control section 30 searches for content data corresponding to the transfer content data described in the first row of the transfer list L1A from within the storage medium 31, and then the processing advances to next step SP52. At step SP52, the control section 30 transfers only a portion, which is designated by the transfer list L1A, of the content data obtained as a result of the search to the portable content reproduction apparatus 14. Then, the processing advances to next step SP53. At step SP53, the control section 30 decides whether or not all of the transfer content data described in the transfer list L1A are completely transferred.

If it is assumed here that the transfer list L1A includes, for example, three rows of the series M1 to M3 as seen in FIG. 8, then the control section 30 acquires a negative result at step SP53 after the transfer of the transfer content data described in the first row is ended. Consequently, the processing returns to step SP51, at which the control section 30 performs transfer of the transfer content data described in the second row. Thus, the control section 30 successively performs transfer of the transfer content data described in the second and third rows. Then, when the transfer of the transfer content data described in the third row, that is, the last row, is ended, an affirmative result is obtained at step SP53. Consequently, the processing now advances to ending step SP54, at which the data transfer processing procedure RT4 is ended.

In accordance with such a data transfer processing procedure RT4 as described above, the control section 30 transfers content data to the portable content reproduction apparatus 14 based on the transfer list L1A.

On the other hand, when the portable content reproduction apparatus 14 receives content data transferred from the content reproduction terminal 13, the control section 40 thereof stores the received content data into the recording medium 41 and updates the management information CI based on the stored content data at step SP19 (FIG. 17).

In accordance with such a procedure of the content transfer process as described above, the control section 30 of the content reproduction terminal 13 and the control section 40 of the portable content reproduction apparatus 14 perform transfer of a content from the content reproduction terminal 13 to the portable content reproduction apparatus 14.

1-6. Action and Effects by the First Embodiment

The content reproduction terminal 13 having the configuration described above stores and retains content data acquired from the content providing server 11 collectively for individual series in the storage medium 31. Further, the content reproduction terminal 13 sets use time within which the portable content reproduction apparatus 14 is used continuously as preset time. Furthermore, if the portable content reproduction apparatus 14 is connected to the content reproduction terminal 13, then the content reproduction terminal 13 detects the free capacity of the recording medium 41 included in the portable content reproduction apparatus 14. Further, the content reproduction terminal 13 detects storable time representative of for what hours content data can be stored in the portable content reproduction apparatus 14 based on the detected free capacity and the format of content data stored and retained in the content reproduction terminal 13 itself.

After the preset time and the storable time are recognized in this manner, the content reproduction terminal 13 first designates content data for the preset time for each of the series from within the storage medium 31. Here, if the content data stored in the storage medium 31 have a data amount exceeding that corresponding to the preset time, then the content reproduction terminal 13 designates part of the content data (that is, a portion for the preset time). However, if the content data stored in the storage medium 31 have a data mount less than that corresponding to the preset time, then the content reproduction terminal 13 designates a plurality of content in the series (that is, content data for the preset time).

Further, the content reproduction terminal 13 designates, from among the content data for the preset time designated for each series, transfer content data for the storable time of the portable content reproduction apparatus 14 to produce a transfer list L1A indicative of the transfer content data. Then, the content reproduction terminal 13 reads out the transfer content data from the storage medium 31 based on the transfer list L1A and transfers the read out transfer content data to the portable content reproduction apparatus 14.

As a result, the content reproduction terminal 13 can transfer content data which require reproduction time corresponding to the use time of the portable content reproduction apparatus 14 to the portable content reproduction apparatus 14. Therefore, an amount of content data as great as possible can be stored into the portable content reproduction apparatus 14 without transferring a useless portion of the content data which protrudes from the use time.

Further, since the content reproduction terminal 13 transfers transfer content data in response to the storable time of the portable content reproduction apparatus 14, it can transfer an amount of transfer content data which corresponds to the storable time of the recording medium 41 included in the portable content reproduction apparatus 14. Therefore, transfer content data can be stored with certainty into the recording medium 41 included in the portable content reproduction apparatus 14 without transferring an exceeding amount of transfer content data which cannot be stored into the recording medium 41.

Further, the content reproduction terminal 13 designates transfer content data for the preset time for the individual series and transfers the designated transfer content data of the series. Consequently, content data of different series can be stored into the portable content reproduction apparatus 14, and therefore, choices of contents to the user can be expanded. In particular, for example, if it is assumed that it is tried to transfer three content data, then where the three content data are contents of first, second and third stories of the same series, the content which is to be selected by the user normally is restricted to the content of the first story. Therefore, in this instance, the number of choices is 1. On the other hand, if the tree content data are contents of the first story of the series M1, first story of the series M2 and first story of the series M3, then the number of choices to the user is three. Therefore, the number of choices can be expanded when compared with that in the case wherein the content data of the same series are transferred.

Further, if the portable content reproduction apparatus 14 is connected to the content reproduction terminal 13, then the content reproduction terminal 13 automatically deletes all or part of those content data which are decided unnecessary from within the recording medium 41 of the portable content reproduction apparatus 14 to increase the free capacity of the recording medium 41 and then transfers new content data. Consequently, only if the portable content reproduction apparatus 14 is connected to the content reproduction terminal 13, then the content reproduction terminal 13 can transfer new content data without causing the user to perform any cumbersome operation.

Since the content reproduction terminal 13 has the configuration described above, the control section 30 thereof sets the use time of the portable content reproduction apparatus 14 by the user as preset time and designates part or all of content data from within the storage medium 31 as transfer content data based on the preset time. Then, the control section 30 transfers the designated content data to the portable content reproduction apparatus 14 through the external connection section 39. Consequently, content data each having reproduction time equal to the use time can be transferred to the portable content reproduction apparatus 14. Therefore, an amount of content data as great as possible can be transferred to the portable content reproduction apparatus 14 without transferring a useless portion of content data which protrudes from the use time. Thus, a content transfer apparatus, a content transfer method and a content transfer program can be implemented by which an amount of content data as great as possible can be provided to a user in accordance with use time by the user.

2. Second Embodiment

Now, a second embodiment of the present invention is described in detail. The second embodiment is similar to the first embodiment described hereinabove except that the content reproduction terminal 13 executes a different storable time detection process. Therefore, description is given below only of a procedure of the storable time detection process while description of the configuration of the content transfer system 1 and the other processes than the storable time detection process which are similar to those of the first embodiment is omitted herein to avoid redundancy.

Similarly as in the first embodiment described hereinabove, the control section 30 of the content reproduction terminal 13 starts the content transfer process illustrated in FIG. 17. Referring to FIG. 17, after the content transfer process is started, the control section 30 successively performs setting of preset time, request for and acquisition of an apparatus ID and request for and acquisition of management information CI at steps SP10, SP11, SP12 and SP14. Then at step SP16, the control section 30 executes a storable time detection process for detecting the storable time of the storage medium 41 included in the portable content reproduction apparatus 14.

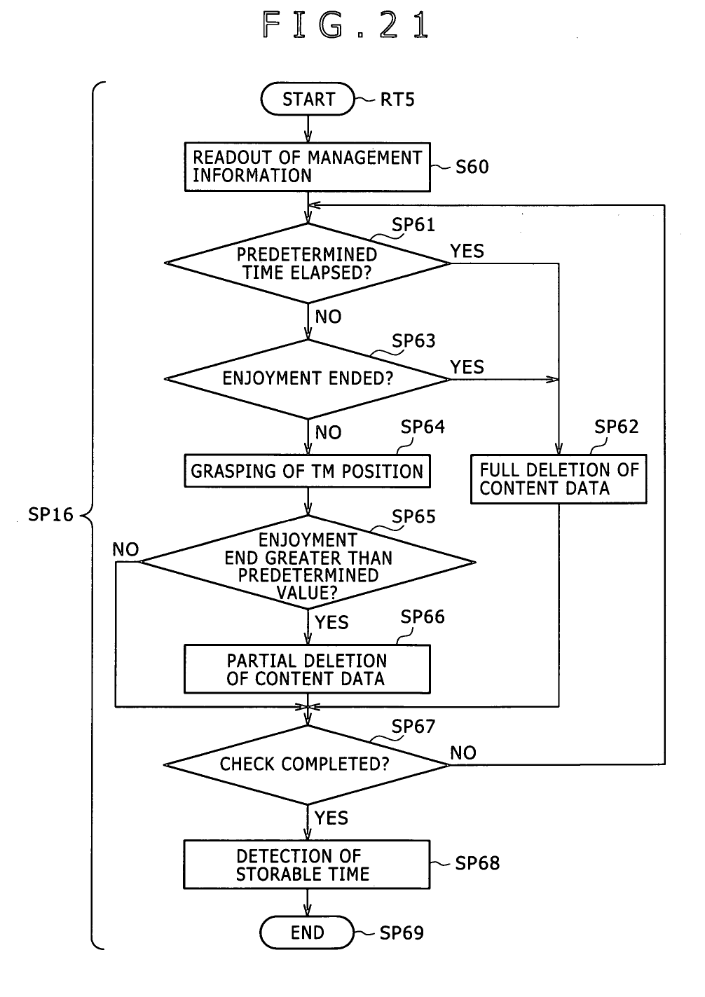

Here, a procedure of the storable time detection process according to the second embodiment which is executed at step SP16 is described with reference to a flow chart of FIG. 21. After the storable time detection processing procedure RT5 is started, the control section 30 reads out management information CI from the temporary storage section 33 at step SP60, and then advances the processing to step SP61. At step SP61, the control section 30 refers to the first row of the management information CI and then compares the date and hour of the last reproduction in the first row with the date and hour at present to decide whether or not, for example, 24 hours or more elapse after the date and hour of the last reproduction.

If an affirmative result is obtained at step SP61, then this signifies that one day or more elapse after the content described in the first row was reproduced last. At this time, the control section 30 decides that the user will not enjoy the content described in the first row any more, and advances the processing to step SP62. At step SP62, the control section 30 deletes content data corresponding to the file name described in the first row of the management information CI from the storage medium 41 of the portable content reproduction apparatus 14 connected to the content reproduction terminal 13 through the external connection section 39 to increase the free capacity of the storage medium 41, and then advances the processing to step SP67. Incidentally, even if the date and hour of the last reproduction is “no production”, an affirmative result is obtained at step SP61 and the pertaining content data are deleted.

On the contrary, if a negative result is obtained at step SP61, then this represents that one day or more do not elapse after the content described in one line was reproduced last. At this time, the control section 30 decides that there is the possibility that the user may enjoy the content described in the first row still more, and advances the processing to step SP63. At step SP63, the control section 30 decides whether or not the enjoyment end confirmation is “ON”.

If an affirmative result is obtained at step SP63, then this represents that it is designated by the user that the enjoyment of the content described in the first row is ended. At this time, the control section 30 advances the processing to step SP62. At step SP62, the control section 30 deletes content data corresponding to the file name described in the first row of the management information CI from the storage medium 41 of the portable content reproduction apparatus 14 connected to the content reproduction terminal 13 through the external connection section 39 to increase the free capacity of the storage medium 41. Thereafter, the processing advances to next step SP67.

On the other hand, if a negative result is obtained at step SP63, then this represents that the enjoyment of the content described in the first row is not ended. At this time, the control section 30 advances the processing to step SP64. At step SP64, the control section 30 confirms the position of the time mark in the first row, then advances the processing to step SP65. At step SP65, the control section 30 decides whether or not the position of the time mark representative of a stopping point of time of the content corresponds, for example, to 90% or more of the reproduction time of the content described in the first row. In other words, the control section 30 decides whether or not the user has ended enjoyment of the content described in the first row by 90% or more.

If an affirmative result is obtained at step SP65, then this represents that the enjoyment of the content described in the first row of the management information CI by the user is ended by 90% or more, that is, almost all of the content has been enjoyed by the user. At this time, the control section 30 advances the processing to step SP66, at which it deletes the portion of the content data corresponding to the file name described in the first row of the management information CI which precedes to the position of the time mark, that is, the portion enjoyed already by the user, to increase the free capacity of the storage medium 41. Thereafter, the processing advances to step SP67.

On the other hand, if a negative result is obtained at step SP65, then this signifies that the user has not ended its enjoyment of the content described in the first row by less than 90%. At this time, the control section 30 advances the processing to step SP67 without deleting the portion of the content data of the content which precedes to the time mark position.

At step SP67, the control section 30 decides whether or not the processes at steps SP61 to SP66 are completed for all of the rows of the management information CI. Here, if the management information CI includes, for example, three rows of the series M1 to M3 as seen in FIG. 11, then the control section 30 obtains a negative result at step SP67 after the processes for one row are ended. Thereafter, the processing returns to step SP61, at which the processing for the second row is started. Then, the processing is successively performed for the second and third rows, and after the processing for the third row (that is, the last row) is completed, an affirmative result is obtained at step SP67. Thereafter, the processing advances to step SP68.

At step SP68, the control section 30 detects the free capacity of the storage medium 41 included in the portable content reproduction apparatus 14. Then, the control section 30 detects the storable time of the portable content reproduction apparatus 14 based on the detected free capacity and the format of the content stored and retained by the portable content reproduction apparatus 14. Thereafter, the processing advances to step ending step SP69, at which the control section 30 ends the storable time detection processing procedure RT5.

In this manner, in the storable time detection processing procedure RT5 according to the second embodiment, when the enjoyment end confirmation of the management information CI is “OFF”, a portion of the content data preceding to the time mark position is not deleted unconditionally. In particular, where the enjoyment end confirmation is “OFF” and enjoyment of a predetermined ratio (as an example, 90%) or more of the content is completed, the portion preceding to the time mark position is deleted from the content data. However, if the enjoyment end confirmation is “OFF” and the enjoyment of the predetermined ratio (as an example, 90%) or more is not completed as yet, then the content data are left retained as they are without deleting the portion of the content data preceding to the time mark position.

In other words, the content reproduction terminal 13 keeps the content retained in the storage medium 41 of the portable content reproduction apparatus 14 until after the user almost completes the enjoyment of the content. This makes it possible, for example, for the user to reproduce a content, whose enjoyment is little completed, once again from the top of the content. As a result, the user is permitted to enjoy the content with a higher degree of certainty.

3. Third Embodiment

Now, a third embodiment of the present invention is described in detail. The third embodiment is similar to the first embodiment described hereinabove except that the content reproduction terminal 13 executes another different storable time detection process. Therefore, description is given below only of a procedure of the storable time detection process while description of the configuration of the content transfer system 1 and the other processes than the storable time detection process which are similar to those of the first embodiment is omitted herein to avoid redundancy.

Similarly as in the first embodiment described hereinabove, the control section 30 of the content reproduction terminal 13 starts the content transfer process illustrated in FIG. 17. Referring to FIG. 17, after the content transfer process is started, the control section 30 successively performs setting of preset time, request for and acquisition of an apparatus ID, and request for and acquisition of management information CI at steps SP10, SP11, SP12 and SP14. Then at step SP16, the control section 30 executes a storable time detection process for detecting the storable time of the storage medium 41 included in the portable content reproduction apparatus 14.

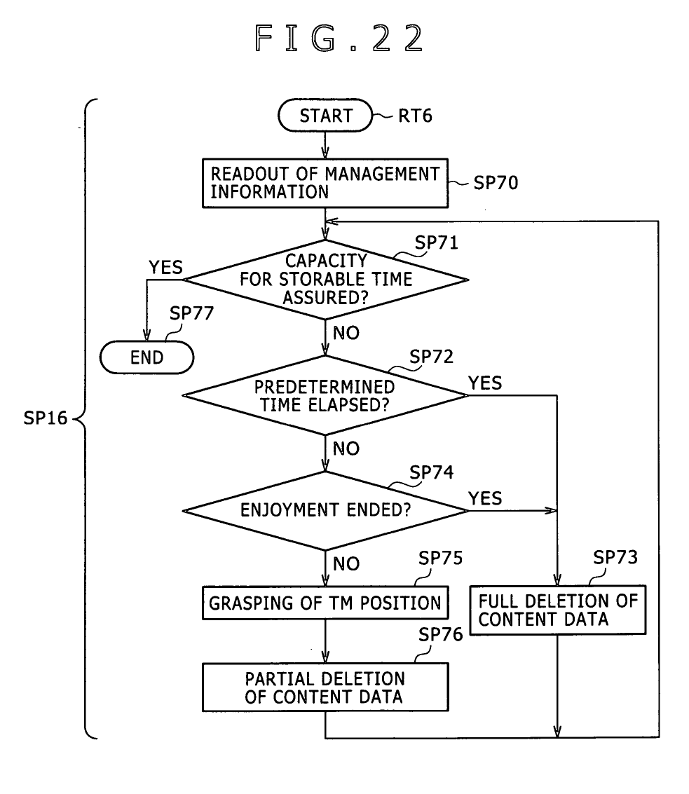

Here, a procedure of the storable time detection process according to the third embodiment which is executed at step SP16 is described with reference to a flow chart of FIG. 22. After the storable time detection processing procedure RT6 is started, the control section 30 of the content reproduction terminal 13 reads out the management information CI from the temporary storage section 33 at step SP70, and then advances the processing to step SP71. At step SP71, the control section 30 sets storable time and detects the free capacity of the storage medium 41 included in the portable content reproduction apparatus 14. Then, the control section 30 decides whether or not the free capacity sufficient for the storable time is assured in the storage medium 41 of the portable content reproduction apparatus 14.

The setting of the storable time may be performed automatically by the control section 30 of the content reproduction terminal 13, for example, based on 50% of the total capacity of the storage medium 41 of the portable content reproduction apparatus 14 and the format of the content data stored and retained in the storage medium 31 of the content reproduction terminal 13. Alternatively, the storable time may be set by inputting by the user through the operation section 34 of the content reproduction terminal 13.

Here, if the free capacity of the storage medium 41 of the portable content reproduction apparatus 14 is almost zero because of stored content data transferred from the content reproduction terminal 13 formerly, then the control section 30 of the content reproduction terminal 13 obtains a negative result at step SP71 and then advances the processing to step SP72. At step S72, the control section 30 refers to the first row of the management information CI and then compares the date and hour of the last reproduction of a content described in the first row with the date and hour at present to decide whether or not, for example, 24 hours or more elapse after the date and hour of the last reproduction.

If an affirmative result is obtained at step SP72, then this signifies that one day or more elapse after the content described in the first row was reproduced last. At this time, the control section 30 decides that the user will not enjoy the content described in the first row any more, and advances the processing to step SP73. At step SP73, the control section 30 deletes content data corresponding to the file name described in the first row of the management information CI from the storage medium 41 of the portable content reproduction apparatus 14 connected to the content reproduction terminal 13 through the external connection section 39 to increase the free capacity of the storage medium 41, and then returns the processing to step SP71. Incidentally, even if the date and hour of the last reproduction is “no production”, an affirmative result is obtained at step SP72 and the pertaining content data are deleted.

On the contrary, if a negative result is obtained at step SP72, then this represents that one day or more do not elapse after the content described in one line was reproduced last. At this time, the control section 30 decides that there is the possibility that the user may enjoy the content described in the first row still more, and advances the processing to step SP74. At step SP74, the control section 30 decides whether or not the enjoyment end confirmation is “ON”.

If an affirmative result is obtained at step SP74, then this represents that it is designated by the user that the enjoyment of the content described in the first row is ended. At this time, the control section 30 advances the processing to step SP73. At step SP73, the control section 30 deletes content data corresponding to the file name described in the first row of the management information CI from the storage medium 41 of the portable content reproduction apparatus 14 connected to the content reproduction terminal 13 through the external connection section 39 to increase the free capacity of the storage medium 41. Thereafter, the processing returns to step SP71.

On the other hand, if a negative result is obtained at step SP74, then this represents that the enjoyment of the content described in the first row is not ended. At this time, the control section 30 advances the processing to step SP75. At step SP75, the control section 30 confirms the time mark position described in the first row and then advances the processing to step SP76. At step SP76, the control section 30 deletes a portion of the content corresponding to the file name described in the first row of the management information CI which precedes to the time mark position, that is, the portion of the content which has been enjoyed already, to increase the free capacity of the storage medium 41. Then, the processing returns to step SP71.

Then, the control section 30 repeats the processes at steps SP72 to SP76 to delete part or all of content data corresponding to the file names described in the second, third, . . . rows of the management information CI to successively increase the free capacity of the storage medium 41 until the free capacity sufficient for the storable time is assured in the storage medium 41 of the portable content reproduction apparatus 14. Then, if the free capacity for the storable time is assured, then an affirmative result is obtained at step SP71, and the processing advances to ending step SP77, at which the storable time detection processing procedure RT6 is ended.

In this manner, in the storable time detection processing procedure RT6 according to the third embodiment, storable time is set first, and then part or all of content data are deleted from the storage medium 41 included in the portable content reproduction apparatus 14 so that the storage capacity sufficient for the storable time may be assured. Thereafter, new transfer content data are transferred to the portable content reproduction apparatus 14.

Consequently, the content reproduction terminal 13 can freely set the storable time only if it is within the capacity of the storage medium 41 included in the portable content reproduction apparatus 14. Further, only if the portable content reproduction apparatus 14 is connected to the content reproduction terminal 13, then the content reproduction terminal 13 can replace that amount of content data stored and retained in the portable content reproduction apparatus 14 which corresponds to the set storable time without causing the user to perform any cumbersome operation.

4. Fourth Embodiment

Now, a fourth embodiment of the present invention is described in detail. The fourth embodiment is similar to the first embodiment described hereinabove except that the portable content reproduction apparatus 14 executes a different content reproduction process. Therefore, description is given below only of a procedure of the content reproduction process while description of the configuration of the content transfer system 1 and the other processes than the content reproduction process which are similar to those of the first embodiment is omitted herein to avoid redundancy.

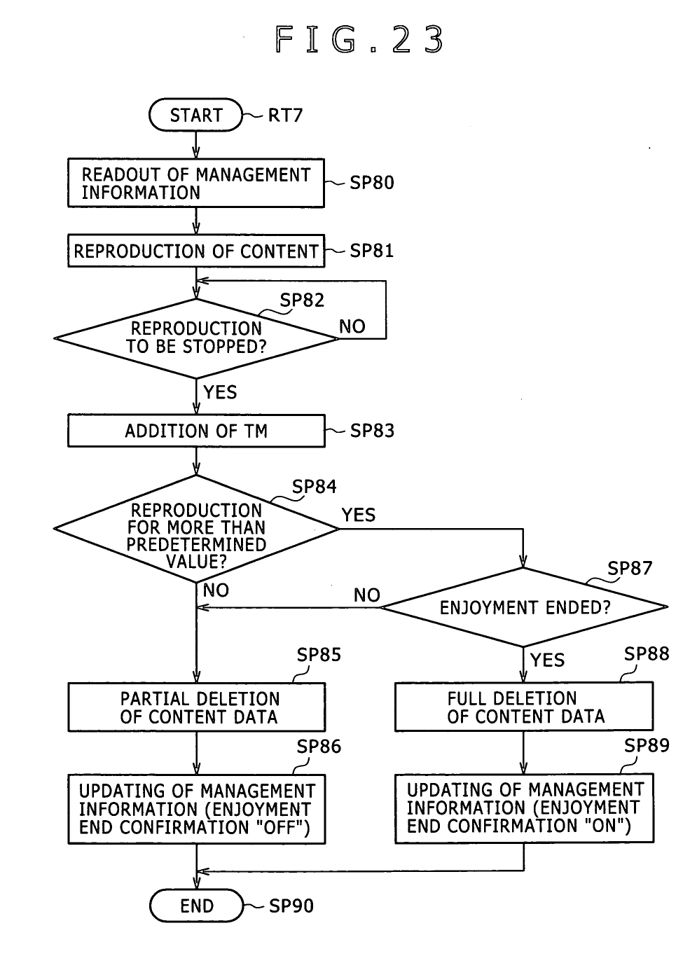

The procedure of the content reproduction according to the fourth embodiment is described with reference to a flow chart of FIG. 23. If the control section 40 of the portable content reproduction apparatus 14 recognizes that a reproduction operation for a content is preformed through the operation section 44, then it starts the content reproduction processing procedure RT7 and advances the processing to step SP80. At step SP80, the control section 40 reads out the management information CI from the storage medium 41 and then advances the processing to step SP81. At step SP81, the control section 40 reads out content data of the content designated by the reproduction operation and outputs an image and sound based on the content data to start reproduction of the content. Thereafter, the processing advances to step SP82.

At step SP82, the control section 40 waits for a stopping operation by the user. Then, if the control section 40 recognizes that a stopping operation is performed, then it stops the reproduction of the content and then advances the processing to step SP83. At step SP83, the control section 40 applies a time mark to a stopping point of time of the content having been reproduced, and then advances the processing to step SP84. At step SP84, the control section 40 decides whether or not the time taken for the reproduction till the stopping time point is equal to or longer than, for example, 90% of the reproduction time of the content.

If a negative result is obtained at step SP84, then this represents that the content has been reproduced by an amount only less than 90% of the reproduction time of the content. At this time, the control section 40 advances the processing to step SP85, at which the control section 40 deletes that portion of the content data of the content having been reproduced which precedes to the time mark position, that is, the portion of the content whose reproduction is ended, based on the position of the time mark applied at step SP83 described hereinabove to increase the free capacity of the storage medium 41. Thereafter, the processing advances to step SP86.

At step SP86, the control section 40 updates the reproduction degree of the content having been reproduced and the last reproduction in the management information CI in response to the stopping time point of the content having been reproduced. Further, the control section 40 updates the time mark position of the content having been reproduced within the management information CI in response to the position of the time mark applied at step SP83. Thereafter, the processing advances to ending step SP90, at which the content reproduction processing procedure RT7 is ended.

On the other hand, if an affirmative result is obtained at step SP84, then this represents that the content has been reproduced by an amount equal to or greater than 90%. At this time, the control section 40 advances the processing to step SP87, at which the control section 40 controls the display section 15 to display a message for the confirmation of whether or not the enjoyment of the content having been reproduced is ended and choices (“Yes” and “No”) to the message. Then, the control section 40 decides whether or not the choice “Yes” is selected by a user operation.

If a negative result is obtained at step SP87, then this represents that it is designated by the user that the enjoyment of the content having been reproduced is not ended. At this time, the control section 40 advances the processing to step SP85, at which the control section 40 deletes that portion of the content data of the content having been reproduced which precedes to the time mark position, that is, the portion of the content whose reproduction is ended, to increase the free capacity of the storage medium 41. Thereafter, the processing advances to step SP86, at which the control section 40 updates the management information CI, and then to ending step SP90, at which the content reproduction processing procedure RT7 is ended.

On the other hand, if an affirmative result is obtained at step SP87, then this represents that it is designated by the user that the content having been reproduced is ended. At this time, the control section-40 advances to the processing to step SP88, at which the control section 40 deletes the content data of the content having been reproduced to increase the free capacity of the storage medium 41. Thereafter, the processing advances to step SP89.

At step SP89, the control section 40 updates the reproduction degree of the content having been reproduced and the last reproduction in the management information CI in response to the stopping point-of time of the content having been reproduced. Further, the control section 40 updates the time mark position of the content having been reproduced in the management information CI in response to the position of the time mark applied to step SP83 described hereinabove. Furthermore, the control section 40 updates the enjoyment end confirmation of the content having been reproduced in the management information CI to “ON” and raises the priority degree from “0” to “5”. Thereafter, the processing advances to step SP90, at which the content reproduction processing procedure RT7 is ended.

In this manner, in the content reproduction processing procedure RT7 according to the fourth embodiment described above, every time reproduction of a content being reproduced is stopped on the portable content reproduction apparatus 14 side, part or all of content data corresponding to the content having been reproduced are deleted to increase the free capacity of the storage medium 41. Consequently, it is not necessary for the content reproduction terminal 13 side to perform deletion of content data from the storage medium 41 of the portable content reproduction apparatus 14. Therefore, the load to the content reproduction terminal 13 side can be reduced.

Actually, in this instance, for example, the processes at steps SP30 to SP36 of the storage time detection processing procedure RT2 in the content transfer process according to the first embodiment described hereinabove with reference to FIG. 18, that is, the process of deleting content data by the content reproduction terminal 13 side, can be omitted. Further, since the processes in the content transfer process can be omitted in this manner, it is possible to reduce the time required for the content transfer process.

5. Fifth Embodiment

Now, a fifth embodiment of the present invention is described in detail. The fifth embodiment is similar to the first embodiment described hereinabove except that the content reproduction apparatus 13 executes a different transfer list production process. Therefore, description is given below only of a procedure of the content reproduction process while description of the configuration of the content transfer system 1 and the other processes than the content reproduction process which are similar to those of the first embodiment is omitted herein to avoid redundancy.

Similarly as in the first embodiment described hereinabove, the control section 30 of the content reproduction terminal 13 starts the content transfer process illustrated in FIG. 17. Referring to FIG. 17, after the content transfer process is started, the control section 30 successively performs setting of preset time, request for and acquisition of an apparatus ID, request for and acquisition of management information CI, and storable time detection at steps SP10, SP11, SP12, SP14 and SP16. Then at step SP17, the control section 30 executes a transfer list production process for producing a transfer list L1A indicative of transfer content data to be transferred to the portable content reproduction apparatus 14.

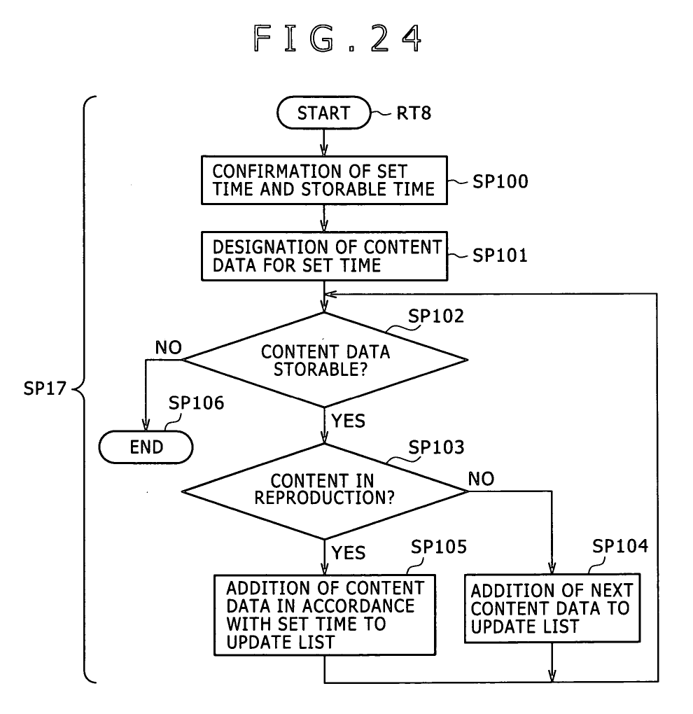

Here, a procedure of the transfer list production process according to the fifth embodiment executed at step SP17 is described with reference to a flow chart of FIG. 24. After the transfer list production processing procedure RT8 is started, the control section 30 of the content reproduction terminal 13 confirms, at step SP100, the preset time set at step SP10 (FIG. 17) described hereinabove and the storable time detected at step SP16 (FIG. 17). Then, the processing advances to next step SP101. At step SP101, the control section 30 designates content data for the preset time from within the folders M1F, M2F, M3F and M4F of the storage medium 41 based on the preset time to produce a transfer object list L1 as shown in FIG. 8.

Actually, when the content data for the preset time are designated from within the folders M1F, M2F, M3F and M4F at step SP101, the control section 30 recognizes a series internal number of each content data stored and retained, or having been stored and retained (that is, deleted after reproduction), in the storage medium 41 of the portable content reproduction apparatus 14 based on the management information CI acquired from the portable content reproduction apparatus 14 and designates content data having a series internal number next to the recognized series internal number. In particular, for example, if content data having the series internal number “1” of the series M1 is stored and retained or has been stored and retained in the storage medium 41 of the portable content reproduction apparatus 14 as seen in FIG. 10, then the control section 30 decides that the content data to be designated from within the folder M1F corresponding to the series M1 is content data having the series internal number “2”. Thus, the control section 30 designates content data M1D₂ having the series internal number “2” from within the folder M1F.

After the content data for the preset time are designated to produce the transfer object list L1 in this manner, the control section 30 advances the processing to next step SP102. At step SP102, the control section 30 decides based on the storable time whether or not the content data for the preset time described in the first row of the transfer object list L1 can be stored into the portable content reproduction apparatus 14. Here, if the storable time is three hours and the preset time is one hour, then the content data for the preset time described in the first row can be stored into the portable content reproduction apparatus 14. Therefore, the control section 30 obtains an affirmative result at step SP102 and advances the processing to next step SP103.

At step SP103, the control section 30 decides based on the management information CI whether or not content data having a series internal number preceding by one to the content data, for example, of the series M1 described in the first row of the transfer object list L1 are stored as content data having a time mark applied thereto and being reproduced in the storage medium 41 of the portable content reproduction apparatus 14.

If a negative result is obtained at step SP103, then this represents that the data having the series internal number preceding by one to the content data described in the first row of the transfer object list L1 are not stored in the storage medium 41. At this time, the control section 40 advances to step SP104. At step SP104, the control section 30 adds the content data for the preset time (for one hour) described in the first row of the transfer object list L1 to the transfer list L1A to update the transfer list L1A. Further, the control section control section 30 recognizes the remaining time (at this time, three hours-one hour) of the storable time. Thereafter, the processing returns to step SP102.

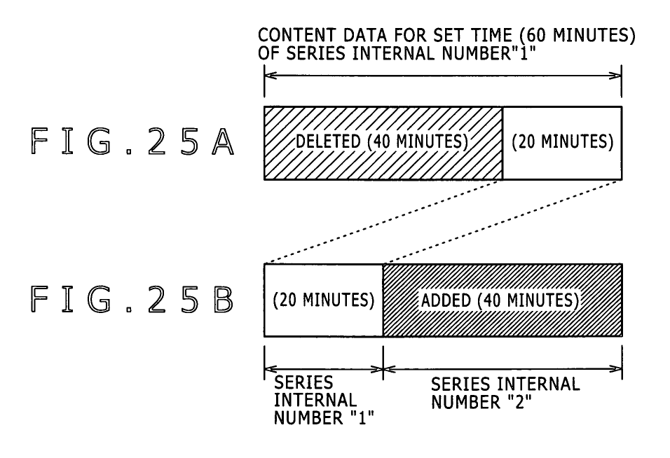

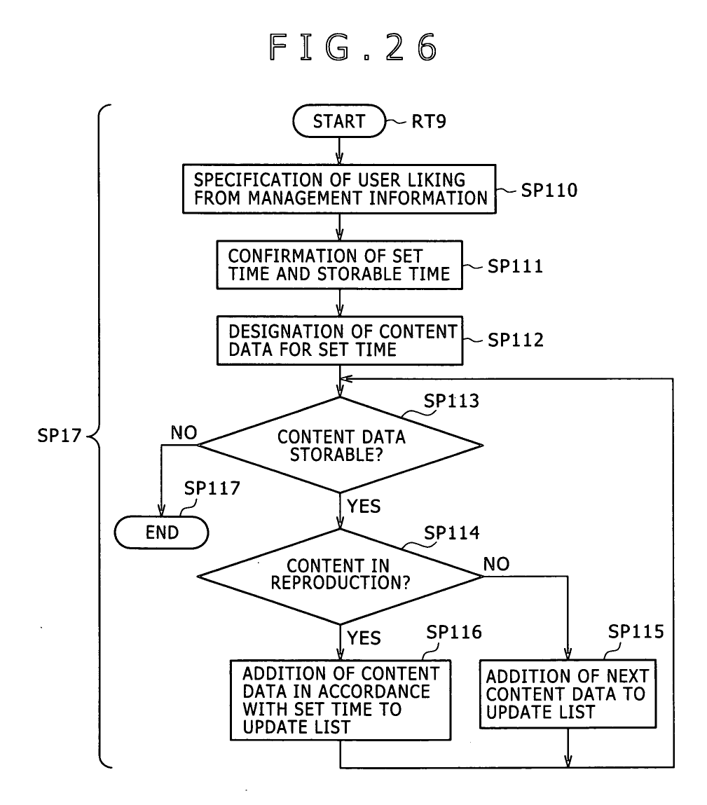

On the other hand, if an affirmative result is obtained at step SP103, then this represents that the content data having the series internal number preceding by one to the content data described in the first row of the transfer object list L1 are being reproduced and the portion thereof preceding to the time mark position is deleted while the remaining portion (for example, the last portion for 20 seconds) remains stored in the storage medium 41 of the portable content reproduction apparatus 14 as seen in FIG. 25A. At this time, the control section 40 advances the processing to step SP105.

At step SP105, the control section 30 designates a predetermined portion of the content data described in the first row of the transfer object list L1 (in this instance, a portion for 40 minutes from the top of the content data) based on the preset time (in this instance, one hour) and the time mark position of the content data having the series internal number preceding by one to the content data described in the first row of the transfer object list L1 as seen in FIG. 25B. Then, the control section 30 adds the designated portion of the content data to the transfer list L1A to update the transfer list L1A and recognizes the remaining time of the storable time (at this time, three hours-40 minutes). Thereafter, the processing returns to step SP102.

In particular, in this instance, the control section 30 designates a portion of the content data described in the first row of the transfer object list L1 such that, from within the content data of the series M1, the portion (for 20 minutes) stored in the portable content reproduction apparatus 14 and the portion (for 40 minutes) to be transferred in the current transfer process have a totaling amount corresponding to the preset time (60 seconds) Then, the control section 30 adds the designated portion of the content data to the transfer list L1A.

Then, the control section 30 repeats the processes at steps SP102 to SP105 until the remaining time of the storable time becomes shorter than the preset time (one hour) thereby to successively add part or all of the content data for the preset time (one hour) described in the second, third, . . . rows of the transfer object list L1 on by one to the transfer list L1A. Then, if the remaining time becomes shorter than the preset time (one hour), then since the content data for the preset time (one hour) cannot be stored into the portable content reproduction apparatus 14 any more, a negative result is obtained at step SP102. Consequently, the processing advances to ending step SP106, at which the transfer list production processing procedure RT8 is ended.

In this manner, in the transfer list production processing procedure RT8 according to the fifth embodiment, transfer content data are designated such that the remaining portion of the content data stored in the storage medium 41 of the portable content reproduction apparatus 14 and the portion of the content data to be transferred in the current transfer process have a totaling amount corresponding to the preset time to produce the transfer list L1A.

Consequently, the content reproduction terminal 13 can normally store and retain content data for the preset time for each series into the storage medium 41 of the portable content reproduction apparatus 14. As a result, content data conforming to the use time of the user can be stored with certainty into the storage medium 41 of the portable content reproduction apparatus 14 irrespective of whether or not the content data are being reproduced.

6. Sixth Embodiment

Now, a sixth embodiment of the present invention is described in detail. The sixth embodiment is similar to the first embodiment described hereinabove except that the content reproduction apparatus 13 executes another different transfer list production process. Therefore, description is given below only of a procedure of the transfer list production process while description of the configuration of the content transfer system 1 and the other processes than the content reproduction process which are similar to those of the first embodiment is omitted herein to avoid redundancy.

Similarly as in the first embodiment described hereinabove, the control section 30 of the content reproduction terminal 13 starts the content transfer process illustrated in FIG. 17. Referring to FIG. 17, after the content transfer process is started, the control section 30 successively performs setting of preset time, request for and acquisition of an apparatus ID, request for and acquisition of management information CI and storable time detection at steps SP10, SP11, SP12, SP14 and SP16. Then at step SP17, the control section 30 executes a transfer list production process for producing a transfer list L1A indicative of transfer content data to be transferred to the portable content reproduction apparatus 14.

Here, a procedure of the transfer list production process according to the sixth embodiment executed at step SP17 is described with reference to a flow chart of FIG. 26. After the transfer list production process procedure RT9 is started, the control section 30 of the content reproduction terminal 13 reads out the management information CI from the temporary storage section 33 and specifies the liking of the user with regard to contents based on the management information CI at step SP110. In this instance, for example, the portable content reproduction apparatus 14 can be operated by the user to designate at least one or more favorite genres to the user, and the designated genres are described as user preference information of the user in the management information CI.

After the liking of the user (for example, favorite genres) is specified in this manner, the control section 30 advances the processing to next step SP111. At step SP30, the control section 30 confirms the preset time set at step SP10 (FIG. 17) described hereinabove and the storable time detected at step SP16 (FIG. 17). Then, the processing advances to next step SP112. At step SP112, the control section 30 designates content data for the preset time from within the folders M1F, M2F, M3F and M4F of the storage medium 41 based on the preset time and the liking of the user to produce a transfer object list L1.

Actually, when the content data for the preset time are designated from within the folders M1F, M2F, M3F and M4F at step SP112, the control section 30 recognizes a series internal number of each content data stored and retained, or having been stored and retained (that is, deleted after reproduction), in the storage medium 41 of the portable content reproduction apparatus 14 based on the management information CI acquired from the portable content reproduction apparatus 14 and designates content data having a series internal number next to the recognized series internal number. In particular, for example, if content data having the series internal number “1” of the series M1 is stored and retained or has been stored and retained in the storage medium 41 of the portable content reproduction apparatus 14 as seen in FIG. 10, then the control section 30 decides that the content data to be designated from within the folder M1F corresponding to the series M1 are content data having the series internal number “2”. Thus, the control section 30 designates the content data M1D₂ having the series internal number “2” from within the folder M1F. Further, in addition to the condition described above, only content data for the preset time may be designated from within each folder which conforms with the liking of the user so that the liking of the user may be reflected on the transfer list L1A.

After the content data for the preset time are designated to produce the transfer object list L1 in accordance with the liking of the user in this manner, the control section 30 advances the processing to next step SP113. At step SP113, the control section 30 decides based on the storable time whether or not the content data for the preset time described in the first row of the transfer object list L1 can be stored into the portable content reproduction apparatus 14. Here, if the storable time is three hours and the preset time is one hour, then the content data for the preset time described in the first row can be stored into the portable content reproduction apparatus 14. Therefore, the control section 30 obtains an affirmative result at step SP113 and advances the processing to next step SP114.

At step SP114, the control section 30 decides based on the management information CI whether or not content data having a series internal number preceding by one to the content data, for example, of the series M1 described in the first row of the transfer object list L1 are stored as content data having a time mark applied thereto and being reproduced in the storage medium 41 of the portable content reproduction apparatus 14.

If a negative result is obtained at step SP114, then this represents that the content data having the series internal number preceding by one to the content data described in the first row of the transfer object list L1 are not stored in the storage medium 41. At this time, the control section 40 advances the processing to step SP115. At step SP115, the control section 30 adds the content data for the preset time (for one hour) described in the first row of the transfer object list L1 to the transfer list L1A to update the transfer list L1A. Further, the control section control section 30 recognizes the remaining time (at this time, three hours-one hour) of the storable time. Thereafter, the processing returns to step SP113.

On the other hand, if an affirmative result is obtained at step SP114, then this represents that the content data having the series internal number preceding by one to the content data described in the first row of the transfer object list L1 are being reproduced and the portion thereof which precedes to the time mark position is deleted while the remaining portion (for example, the last portion for 20 seconds) remains stored in the storage medium 41 of the portable content reproduction apparatus 14 as seen in FIG. 25A. At this time, the control section 40 advances the processing to step SP116.

At step SP116, the control section 30 designates a predetermined portion of the content data described in the first row of the transfer object list L1 (in this instance, a portion for 40 minutes from the top of the content data) based on the preset time (in this instance, one hour) and the time mark position of the content data having the series internal number preceding by one to the content data described in the first row of the transfer object list L1 as seen in FIG. 25B. Then, the control section 30 adds the designated portion of the content data to the transfer list L1A to update the transfer list L1A and recognizes the remaining time of the storable time (at this time, three hours-40 minutes). Thereafter, the processing returns to step SP113.

In particular, in this instance, the control section 30 designates a portion of the content data described in the first row of the transfer object list L1 such that, from within the content data of the series M1, the portion (for 20 minutes) stored in the portable content reproduction apparatus 14 and the portion (for 40 minutes) to be transferred in the current transfer process have a totaling amount corresponding to the preset time (60 seconds). Then, the control section 30 adds the designated portion of the content data to the transfer list L1A.

Then, the control section 30 repeats the processes at steps SP113 to SP116 thereby to successively add part or all of the content data for the preset time (one hour) described in the second, third, . . . rows of the transfer object list L1 on by one to the transfer list L1A until the remaining time of the storage time becomes shorter than the preset time (one hour). Then, if the remaining time becomes shorter than the preset time (one hour), then since the content data for the preset time (one hour) cannot be stored into the portable content reproduction apparatus 14 any more, a negative result is obtained at step SP113. Consequently, the processing advances to ending step SP117, at which the transfer list production processing procedure RT9 is ended.

In this manner, in the transfer list production processing procedure RT9 according to the sixth embodiment, transfer content data to be transferred to the portable content reproduction apparatus 14 are designated in accordance with the liking of the user to produce a transfer list L1A. Consequently, only if the portable content reproduction apparatus 14 is connected to the content reproduction terminal 13, then the content reproduction terminal 13 can transfer content data favorite to the user and suitable for the use time of the user to the portable content reproduction apparatus 14 so as to be stored into the portable content reproduction apparatus 14 without causing the user to perform any cumbersome operation.

7. Other Embodiments

In the embodiments described above, the present invention is applied to transfer of content data from the content reproduction terminal 13 to the portable content reproduction apparatus 14. However, the present invention is not limited to this. For example, the present invention may be applied to transfer of data otherwise, for example, from the content providing server 11 to the portable content reproduction apparatus 14. In this instance, for example, the portable content reproduction apparatus 14 includes a communication section capable of establishing a connection to a network using a wireless communication while the content providing server 11 is additionally provided with the configuration of the content reproduction terminal 13 such that the portable content reproduction apparatus 14 can acquire content data from the content providing server 11. At this embodiment, the content providing server 11 can provide content data by subscription method. In subscription method, contents data can be provided from the content providing server 11 to the portable content reproduction apparatus 14 once a day, or when new contents are updated at the content providing server 11, or the portable content reproduction apparatus 14 still does not have a newly updated contents. The registered groups (news or talk-show, etc) which the user wants to subscribe are used similarly as folders described at FIG. 7. Similarly to the first embodiment, the transfer list can be made from the registered groups. Further, the present invention may be applied to transfer of content data between any other various apparatus. In particular, the present invention can be suitably applied to transfer of content data to an apparatus whose use time is restricted to some degree depending upon an application thereof like the portable content reproduction apparatus 14.

Further, in the embodiments described hereinabove, content data including image data and sound data are used. However, according to the present invention, the data to be used are not limited to such content data, but any other various content data may be used such as content data including only image data or only sound data.

Further, in the embodiments described hereinabove, the use time of the portable content reproduction apparatus 14 is set as preset time by the content reproduction terminal 13 side. However, according to the present invention, the setting of the use time is not limited to this. In particular, the portable content reproduction apparatus 14 may set the use time of the portable content reproduction apparatus 14 itself as preset time and place the preset time into the management information CI so that the content reproduction terminal 13 can recognize the preset time from the management information CI. In other words, the setting of the preset time may be performed not by the content reproduction terminal 13 but by the content providing server 11 or the portable content reproduction apparatus 14. Alternatively, for example, the portable content reproduction apparatus 14 may include a timer such that the time after the power supply to the portable content reproduction apparatus 14 is turned on until the power supply is turned off is measured and this is used as the use time.

Further, in the embodiments described hereinabove, an equal period of time is set as the preset time for all folders. However, according to the present invention, the setting of the preset time is not limited to this, but the preset time may be set otherwise so as to differ among different folders. Since similar contents are retained in the same folder, the reproduction time periods of the contents in the same folder substantially coincide with each other. In this instance, the preset time for the folder may be set automatically based on an average reproduction time period of one of contents in the same folder.

Further, in the embodiments described hereinabove, the content reproduction terminal 13 detects storable time based on the free capacity of the portable content reproduction apparatus 14 and the format of content data and designates transfer content data based on the storable time and the preset time. However, according to the present invention, the designation of transfer content data is not limited to this. In particular, the content reproduction terminal 13 may detect the capacity of content data for the preset time based on the preset time and the format of content data and designate transfer content data for the preset time based on the detected capacity and the free capacity of the portable content reproduction apparatus 14. In other words, not the time but the capacity may be used to designate transfer content data.

Further, in the embodiments described hereinabove, the content reproduction terminal 13 manages content data collectively for individual series based on the content ID of the content data. However, according to the present invention, the management of the content data is not limited to this. For example, the content data may be collected in response to a user operation so that the user can favorably group the contents. Alternatively, content data may be collected otherwise in response to, for example, the genre, distribution source, acquisition source or the like.

Further, in the embodiments described hereinabove, the portable content reproduction apparatus 14 decides a portion of each content whose reproduction is ended based on the time mark position of the management information CI. However, according to the present invention, the decision of such portion is not limited to this, but a portion of each content whose reproduction is ended may be decided based on the reproduction degree of the management information CI.

Further, in the embodiments described hereinabove, the content reproduction terminal 13 decides a portion of each content whose reproduction is completed based on the time mark position of the management information CI. However, according to the present invention, the decision is not limited to this. In particular, a portion of each content whose reproduction is ended may be decided otherwise based on the reproduction degree of the management information CI.

Further, in the embodiments described hereinabove, the content reproduction terminal 13 designates content data of a content next to a content reproduced by the portable content reproduction apparatus 14 or content data of a content according to the liking of the user as transfer content data based on the time mark position, enjoyment end confirmation, user preference information and so forth of the management information CI. However, according to the present invention, the designation is not limited to this. For example, content data of a content next to a content having a high priority degree may be designated preferentially as transfer content data based on the priority degree of the management information CI. It is to be noted that different preset time may be set to different folders based on the priority degree. For example, where the priority degree of the series M1 to M3 is 5 and the priority degree of the series M2 is 0 in FIG. 11, the preset time for transfer may be set such that the time to be taken for subsequent transfer of content data of the series M1 or M3 is increased to one hour and 10 minutes whereas the time for subsequent transfer of content data of the series M2 is decreased by 10 minutes and hence to 50 minutes. In this manner, the preset time to be taken for transfer may be varied for each folder based on the priority degree.

Further, in the embodiments described hereinabove, after a content is reproduced by 90% or more thereof, when the reproduction stops, a message for the confirmation of whether or not enjoyment of the content is ended and choices to the message are displayed on the display section 15 of the portable content reproduction apparatus 14. However, according to the present invention, the display is not limited to this. For example, upon stopping of reproduction, a message for the confirmation of whether or not enjoyment of the content is ended and choices to the message may be displayed without depending upon by what percent a content is reproduced, and such percentage may be set by the user.

Further, in the embodiments described hereinabove, when the content reproduction terminal 13 receives content data from the content providing server 11, it produces index information ID from the received content data and adds the produced index information ID to the content data. However, according to the present invention, handling of such index information ID is not limited to this. For example, the content providing server 11 may produce index information ID and distribute content data to which the index information ID is added to the content reproduction terminal 13. Alternatively, the portable content reproduction apparatus 14 may produce index information ID from content data received from the content reproduction terminal 13 and add the produced index information ID to the content data.

Further, in the embodiments described hereinabove, the content reproduction terminal 13 produces the transfer object list L1 and the transfer list L1A separately from each other. However, according to the present invention, the production of the transfer object list L1 and the transfer list L1A is not limited to this. For example, after the content reproduction terminal 13 produces the transfer object list L1, it may delete any unnecessary portion of content data described in the transfer object list L1 (a portion of content data which protrudes from the storable time) such that the transfer object list L1 from which the unnecessary portion is deleted is used as it is as the transfer list L1A.

Further, in the sixth embodiment described hereinabove, the portable content reproduction apparatus 14 side allows the user to register user preference information of the user itself. However, according to the present invention, the registration of user preference information is not limited to this. For example, the content reproduction terminal 13 side may allow the user to register user preference information of the user itself. Alternatively, the portable content reproduction apparatus 14 side may decide, based on the management information CI, a genre of a content which has been reproduced to the last end or a genre of a series reproduced frequently as a genre favorite to the user and register the decided genre as user preference information.

Further, in the embodiments described hereinabove, the control section 30 of the content reproduction terminal 13 and the control section 40 of the portable content reproduction apparatus 14 execute the processing procedures RT1 to RT9 described hereinabove as software in accordance with programs installed therein in advance. However, according to the present invention, the execution of the processing procedures RT1 to RT9 is not limited to this, and the processing procedures RT1 to RT9 may be executed by hardware. Alternatively, a program for executing the processing procedures RT1 to RT9 may be recorded on a recording medium such as a CD (Compact Disk).

Further, in the embodiments described hereinabove, the content providing server 11 is composed of the control section 20, storage medium 21 and communication section 22. Meanwhile, the content reproduction terminal 13 as a content transfer apparatus and an information processing apparatus is composed of the control section 30, storage medium 31, read-only storage section 32, temporary storage section 33, operation section 34, communication section 35, image and sound processing section 36, display section 37, sound outputting section 38 and external connection section 39. Further, the portable content reproduction apparatus 14 is composed of the control section 40, storage medium 41, read-only storage section 42, temporary storage section 43, operation section 44, external connection section 45, display section 15, sound outputting section 16 and image and sound processing section 46. However, according to the present invention, the configuration of any of the content providing server 11, content reproduction terminal 13 and portable content reproduction apparatus 14 is not limited to this. In particular, any of the content providing server 11, content reproduction terminal 13 and portable content reproduction apparatus 14 may be composed of various other components only if similar functions are implemented.

Incidentally, the content transfer system 1 shown in FIG. 1 corresponds to the content reproduction terminal 13 shown in FIG. 4, and the communication section 2 shown in FIG. 1 corresponds to the communication section 35 shown in FIG. 4. Further, the designation section 4, control section 5, capacity detection section 6, list production section 7 and index information production section 8 shown in FIG. 1 correspond to the control section 30 shown in FIG. 4. Furthermore, the storage section 3 shown in FIG. 1 corresponds to the storage medium 31 shown in FIG. 4.

The present invention can be suitably applied to content transfer apparatus such as a personal computer and a hard disk recorder.

While preferred embodiments of the present invention have been described using specific terms, such description is for illustrative purposes only, and it is to be understood that changes and variations may be made without departing from the spirit or scope of the following claims.

1. A content transfer apparatus, comprising:
a communication section configured to communicate with an external apparatus;
a storage section configured to store a plurality of content data;
a designation section configured to designate at least part of the content data as transfer content data to be transferred to the external apparatus from the storage section based on a preset time set in advance; and
a control section configured to control the communication section to transfer the transfer content data to the external apparatus.

2. The content transfer apparatus according to claim 1, wherein
when the reproduction time of the content data is longer than the preset time, the designation section designates part of the content data as the transfer content data so that the reproduction time of the transfer content data is shorter than the preset time, and
when the reproduction time of the content data is shorter than the preset time, the designation section designates all of the content data as the transfer content data.

3. The content transfer apparatus according to claim 1, wherein the storage section divides the plural content data into a plurality of groups of content data which individually relate to each other and stores the divided content data; and
the designation section designates the transfer content data from different ones of the groups based on the preset time.

4. The content transfer apparatus according to claim 3, wherein each of the groups has a different time period set as the preset time.

5. The content transfer apparatus according to claim 1, further comprising
a capacity detection section configured to detect a storage capacity of the external apparatus through the communication section, wherein
the designation section designates at least part of the content data as the transfer content data from the storage section based on the preset time and a result of the detection by the capacity detection section.

6. The content transfer apparatus according to claim 1, further comprising
a list production section configured to produce a list of the transfer content data designated by the designation section, wherein
the control section controls the communication section to transfer the transfer content data to the external apparatus based on the list of the transfer content data.

7. The content transfer apparatus according to claim 1, further comprising
an index information production section configured to extract part of the content data to produce index information for presenting the substance of the content data.

8. The content transfer apparatus according to claim 1, wherein the control section causes the external apparatus to delete transfer content data whose reproduction is ended from within the transfer content data transferred to the external apparatus.

9. The content transfer apparatus according to claim 1, wherein the control section causes the external apparatus to delete part of the transfer content data whose reproduction is ended from within the transfer content data transferred to the external apparatus and being reproduced.

10. A content transfer method, comprising:
designating at least part of stored content data as transfer content data to be transferred to an external apparatus based on a preset time set in advance; and
transferring the transfer content data to the external apparatus.

11. The content transfer method according to claim 10, wherein the stored content data includes a plurality of content data stored divisionally in a plurality of groups of content data which individually relate to each other; and
the designation step includes designating the transfer content data from different ones of the groups based on the preset time.

12. A recording medium recorded with a content transfer program for causing an information processing apparatus to execute a content transfer method, the method comprising:
designating at least part of stored content data as transfer content data to be transferred to an external apparatus based on a preset time set in advance; and
transferring the transfer content data to the external apparatus.

13. The recording medium according to claim 12, wherein the stored content data includes a plurality of content data stored divisionally in a plurality of groups of content data which individually relate to each other; and
the designation step includes designating the transfer content data from different ones of the groups based on the preset time.
